(19) United States
(12) Patent Application Publication
(10) Pub. No.: US 2026/0129584 A1
(43) Pub. Date: May 7, 2026

(54) SYSTEMS, APPARATUSES, METHODS, AND NON-TRANSITORY COMPUTER-READABLE STORAGE DEVICES FOR WIRELESS COMMUNICATION EMPLOYING COORDINATED SPATIAL REUSE AND DYNAMIC SUB-BAND OPERATIONS FOR MULTI-ACCESS-POINTS

(71) Applicant: Huwei Technologies Co., Ltd., Shenzhen (CN)

(72) Inventors: Mahmoud Hasabelnaby, Kelowna (CA); Osama Aboul-Magd, Kanata (CA); Jung Hoon Suh, Kanata (CA); Sara Norouzi, Vancouver (CA); Yan Xin, Kanata (CA)

(21) Appl. No.: 18/937,801

(22) Filed: Nov. 5, 2024

(51) Int. Cl. H04W 52/02

(52) U.S. Cl. CPC H04W 52/0258; H04W 52/0219

(57) ABSTRACT

A communication method has the step of: communicating with an access point (AP) to determine a coordinated spatial reuse (CSR) arrangement therewith, the CSR arrangement comprising information of a first channel, a second channel, a service period (SP) or transmission opportunity (TXOP), and one or more CSR-related parameters; broadcasting to a plurality of stations (STAs) a first frame comprising the CSR arrangement; during the SP or TXOP, communicating with a first subset of the plurality of STAs over the first channel using the one or more CSR-related parameters; and during the SP or TXOP, communicating with a second subset of the plurality of STAs over the second channel.

### FIELD OF THE DISCLOSURE

The present disclosure relates generally to communication systems, apparatuses, methods, and non-transitory computer-readable storage devices, and in particular to systems, apparatuses, methods, and non-transitory computer-readable storage devices for wireless communication employing coordinated spatial reuse (CSR) and dynamic sub-band operations (DSOs) for multi-access-points (MAPs).

### BACKGROUND

Wireless communication systems such as IEEE 802.11 series (that is, WI-FI® series; WI-FI is a registered trademark of Wi-Fi Alliance, Austin, TX, USA) are known. However, in traditional WI-FI® networks, access points (APs) operate independently, which can lead to issues such as Overlapping Basic Service Set (OBSS) interference, suboptimal resource allocation, inconsistent user experiences (especially as network density increases), and/or the like.

Multi-AP (MAP) coordination aims at enhancing network efficiency and user experience in environments with multiple APs, such as WI-FI® networks in densely populated areas. Among the MAP coordination technologies, coordinated spatial reuse (CSR) at the Transmission Opportunity (TXOP; which is a transmission opportunity granted by the AP to the non-AP station (STA)) level with power control is a prominent example, aiming to improve the efficiency and capacity of WI-FI® networks by optimizing the use of the radio spectrum. However, one of the primary concerns associated with TXOP-based CSR is its high computational complexity. Moreover, the effectiveness of CSR mechanisms can significantly diminish for cell-edge STAs operating within OBSSs.

### SUMMARY

According to one aspect of this disclosure, there is provided a communication method comprising: communicating with an access point (AP) to determine a coordinated spatial reuse (CSR) arrangement therewith, the CSR arrangement comprising information of a first channel, a second channel, a service period (SP) or transmission opportunity (TXOP), and one or more CSR-related parameters; broadcasting to a plurality of stations (STAs) a first frame comprising the CSR arrangement; during the SP or TXOP, communicating with a first subset of the plurality of STAs over the first channel using the one or more CSR-related parameters; and during the SP or TXOP, communicating with a second subset of the plurality of STAs over the second channel.

In some embodiments, the first channel is in a primary band and the second channel is a dynamic sub-band operation (DSO) channel in a secondary band.

In some embodiments, the one or more CSR-related parameters comprise a maximum transmit power; and said during the SP or TXOP, communicating with the first subset of the plurality of STAs over the first channel using the one or more CSR-related parameters comprises: communicating with the first subset of the plurality of STAs over the first channel under the restriction of the maximum transmit power.

In some embodiments, the communication method further comprises: partitioning the plurality of STAs into the first and second subsets based on its STA's reporting of beacon power from neighboring interfering APs that is measured periodically.

In some embodiments, the CSR arrangement comprises the information of the SP; and the first frame is configured to trigger the first subset of the plurality of STAs to wake-up at a start of the SP, and to trigger the second subset of the plurality of STAs to wake-up before the start of the SP.

In some embodiments, the communication method further comprises: sending to the plurality of STAs a second frame to confirm awake statuses of the plurality of STAs and the first or second channel that the plurality of STAs are to use.

In some embodiments, the second frame is a trigger frame.

In some embodiments, the second frame is a multi-user request-to-send (MU-RTS) trigger frame, a buffer status report poll trigger frame (BSRP TF), a basic trigger frame, a multi-user block acknowledgement (ACK) request (MU-BAR) trigger frame, or a Multi-STA block ACK (Multi-STA BA).

In some embodiments, the communication method further comprises: receiving responses from the first subset of the plurality of STAs over the first channel, and receiving responses from the second subset of the plurality of STAs over the second channel.

In some embodiments, the first frame comprises a single target wake time (TWT) element or two aligned trigger-based broadcast TWT elements.

In some embodiments, the first frame comprises two aligned trigger-based broadcast TWT elements; and each of the two aligned trigger-based broadcast TWT elements comprises a Broadcast TWT Parameter Set field; the Broadcast TWT Parameter Set field comprises a Request Type field; the Request Type field comprises a Trigger field having a value of one; and the Request Type field further comprises a Broadcast TWT Recommendation field having a value of five for indicating using the first channel or a value of six for indicating using the second channel.

In some embodiments, the first frame further comprises an CSR Information field for indicating information related to the first channel, a DSO or Enhanced Subchannel Selective Transmission (SST) Information field for indicating information related to the second channel, or a combination thereof.

In some embodiments, each TWT element comprises a TWT Channel field for indicating a location of the second channel.

In some embodiments, the first frame comprises a single TWT element; and the second frame comprises information of the first subset of the plurality of STAs, and information of the second subset of the plurality of STAs.

In some embodiments, the second frame further comprises an Intermediate Frame Check Sequence (FCS) User Information field between the information of the first subset and information of the second subset, and a Padding field of a variable length after the information of the second subset. Also, the Intermediate FCS User Information field may be included after the STA Info list before the Padding field.

In some embodiments, the Intermediate FCS User Information field comprises a FCS AID greater than 2007; and the Intermediate FCS User Information field comprises a first 12-bit FCS Association ID (AID), a 28-bit first portion of the FCS, a second 12-bit FCS AID, and a second portion of the FCS.

In some embodiments, the communication method further comprises: receiving a third frame; wherein the third frame is configured for triggering said broadcasting to the plurality of STAs the first frame comprising the CSR arrangement; wherein the CSR arrangement comprises the information of the TXOP; and wherein the first frame is configured to trigger the first subset of the plurality of STAs to communicate over the first channel using the one or more CSR-related parameters, and to trigger the second subset of the plurality of STAs to communicate over the second channel.

In some embodiments, the first frame is configured for triggering each of the plurality of STAs to determine whether to use the first channel or to use the second channel for communication.

In some embodiments, the first frame is configured for triggering each of the plurality of STAs to determine whether to use the first channel or to use the second channel for communication based on a comparison of a received signal strength (RSSI) of the first frame and an Overlapping Basic Service Set (OBSS) packet detection (OBSS PD) threshold.

According to one aspect of this disclosure, there is provided one or more circuits such as one or more processors for performing any of the above-described methods.

According to one aspect of this disclosure, there is provided one or more processors functionally connected to one or more memories for performing any of the above-described methods.

According to one aspect of this disclosure, there is provided one or more processors functionally coupled to one or more non-transitory computer-readable storage media, wherein the one or more non-transitory computer-readable storage media comprise computer-executable instructions; and wherein the instructions, when executed, cause the one or more processors to perform any of the above-described methods.

According to one aspect of this disclosure, there is provided one or more non-transitory computer-readable storage media comprising computer-executable instructions, wherein the instructions, when executed, cause one or more circuits such as one or more processors to perform any of the above-described methods.

According to one aspect of this disclosure, there is provided an apparatus comprising: one or more processors functionally connected to one or more non-transitory computer-readable storage media such as one or more memories for performing any of the above-described methods.

According to one aspect of this disclosure, there is provided an apparatus, and configured to perform the any of above-described methods and their embodiments. Specifically, the apparatus includes one or more units configured to perform the any of above-described methods and their embodiments.

According to one aspect of this disclosure, there is provided a computer-readable storage medium. The computer-readable storage medium stores a computer program, and when the computer program is executed by an apparatus, the apparatus is enabled to implement the any of above-described methods and their embodiments.

According to one aspect of this disclosure, there is provided a computer program product including one or more instructions. When the instructions are executed by an apparatus such as a computer, the apparatus is enabled to implement the any of above-described methods and their embodiments.

According to one aspect of this disclosure, there is provided a computer program. When the computer program is executed by a computer, an apparatus is enabled to implement the any of above-described methods and their embodiments.

According to one aspect of this disclosure, there is provided a communication system. The communication system includes a first communication-node and/or a second communication-node, the first communication-node is configured to perform any of the above-described methods regarding with the first communication-node as stated above, and the second communication-node is configured to perform any of the above-described methods regarding with the second communication-node as stated above.

According to one aspect of this disclosure, there is provided an apparatus for implementing any of the above-described methods in any possible implementation of the foregoing aspects.

### BRIEF DESCRIPTION OF THE DRAWINGS

FIG. 1 is a simplified schematic diagram showing a communication system, according to some embodiments of this disclosure;

FIG. 2 is a simplified schematic diagram of an access point (AP) of the communication network of the communication system shown in FIG. 1;

FIG. 3 is a simplified schematic diagram of a station (STA) of the communication system shown in FIG. 1;

FIG. 4A is a schematic diagram showing a conventional bi-directional coordination method for managing transmit power in coordinated spatial reuse (CSR);

FIG. 4B is a schematic diagram showing a conventional one-way coordination method for managing transmit power in CSR;

FIG. 5 is a schematic diagram showing an example of a conventional CSR method at the Transmission Opportunity (TXOP) level with power control;

FIG. 6A is a schematic diagram showing an example of classifies the STAs associated with each of a plurality of APs into a subset of inner STAs and a subset of outer STAs.

FIG. 6B is a schematic diagram showing a conventional method of scheduling reuse service periods (SPs) and orthogonal SPs over the long term to optimize network resource management and enhance the performance of connected devices;

FIG. 6C is a schematic diagram showing a conventional per-TXOP framework for CSR scheduling;

FIG. 7 is a schematic diagram showing an enhanced SP-CSR method employing dynamic sub-band operation (DSO), according to some embodiments of this disclosure;

FIG. 8 is a timing diagram showing an example of the details of operations of the enhanced SP-CSR method within a shared SP between a sharing AP and a shared AP, according to some embodiments of this disclosure;

FIG. 9A is a schematic diagram showing the structure of a broadcast target wake time (TWT) element;

FIG. 9B is a schematic diagram showing the structure of the Control field of the broadcast TWT element shown in FIG. 9A;

FIG. 9C is a schematic diagram showing the structure of a Broadcast TWT Parameter Set field in the TWT Parameter Information field of the broadcast TWT element shown in FIG. 9A;

FIG. 9D is a schematic diagram showing the structure of the Request Type field of the Broadcast TWT Parameter Set field shown in FIG. 9C;

FIG. 10 is a schematic diagram showing the structure of a modified Broadcast TWT Parameter Set field in the TWT Parameter Information field of the TWT element shown in FIG. 9A, according to some embodiments of this disclosure;

FIG. 11 is a schematic diagram showing the structure of the modified Request Type field of the modified Broadcast TWT Parameter Set field shown in FIG. 10, according to some embodiments of this disclosure;

FIG. 12 is a schematic diagram showing the structure of the Individual TWT Parameter Set field of a prior-art individual TWT element;

FIG. 13 is a schematic diagram showing the structure of the extended TWT Channel field of the Individual TWT Parameter Set field of a modified individual TWT element, for enhanced SST or DSO, according to some embodiments of this disclosure;

FIG. 14A is a schematic diagram showing the structure of the enhanced SST or DSO Information field of the modified Broadcast TWT Parameter Set field shown in FIG. 10, according to some embodiments of this disclosure;

FIG. 14B is a schematic diagram showing the structure of the enhanced SST or DSO Information field of the modified Broadcast TWT Parameter Set field shown in FIG. 10, according to some other embodiments of this disclosure;

FIG. 15A is a schematic diagram showing the structure of the CSR information field of the modified Broadcast TWT Parameter Set field shown in FIG. 10, according to some embodiments of this disclosure;

FIG. 15B is a schematic diagram showing the structure of the CSR information field of the modified Broadcast TWT Parameter Set field shown in FIG. 10, according to some other embodiments of this disclosure;

FIG. 15C is a schematic diagram showing the structure of the CSR information field of the modified Broadcast TWT Parameter Set field shown in FIG. 10, according to yet some other embodiments of this disclosure;

FIG. 16 is a timing diagram showing an example of the details of operations of the enhanced SP-CSR method within a shared SP between a sharing AP and a shared AP, according to some embodiments of this disclosure;

FIG. 17 is a schematic diagram showing the structure of a trigger frame sent by the shared AP for triggering one or more outer STAs associated thereof to switch to their designated DSO channels, and to trigger one or more inner STAs to switch to their designated CSR channels, according to some embodiments of this disclosure;

FIG. 18 is a schematic diagram showing the structure of the Intermediate FCS User Information field of the trigger frame shown in FIG. 17, according to some embodiments of this disclosure;

FIG. 19 is a schematic diagram showing the structure of the Trigger Dependent User Info field of a MU-BAR trigger frame;

FIG. 20 is a schematic diagram showing the structure of the BAR Control field of the Trigger Dependent User Info field shown in FIG. 19;

FIG. 21 is a timing diagram showing an example of the details of operations of the enhanced SP-CSR method within a shared SP between a sharing AP and a shared AP, according to some embodiments of this disclosure;

FIG. 22 is a timing diagram showing an example of the details of operations of the enhanced SP-CSR method within a shared SP between a sharing AP and a shared AP, according to some other embodiments of this disclosure;

FIG. 23 is a timing diagram showing an example of the details of operations of an enhanced TXOP-CSR method employing DSO within a shared SP between a sharing AP and a shared AP, according to some embodiments of this disclosure; and

FIG. 24 is a timing diagram showing an example of the details of operations of an enhanced TXOP-CSR method employing DSO within a shared SP between a sharing AP and a shared AP, according to some other embodiments of this disclosure.

### DETAILED DESCRIPTION

Embodiments disclosed herein relate to systems, apparatuses, methods, and non-transitory computer-readable storage devices for wireless communication. The wireless communication systems, apparatuses, and methods disclosed herein may be any suitable systems, apparatuses, and methods for transmitting wireless signals. Examples of such systems may be wireless local-area network (WLAN) Ultra High Reliability (UHR) systems (for example, IEEE 802.11bn or WI-FI® 8 systems), 5G or 6G wireless mobile communication systems, and the like.

### A. System Structure

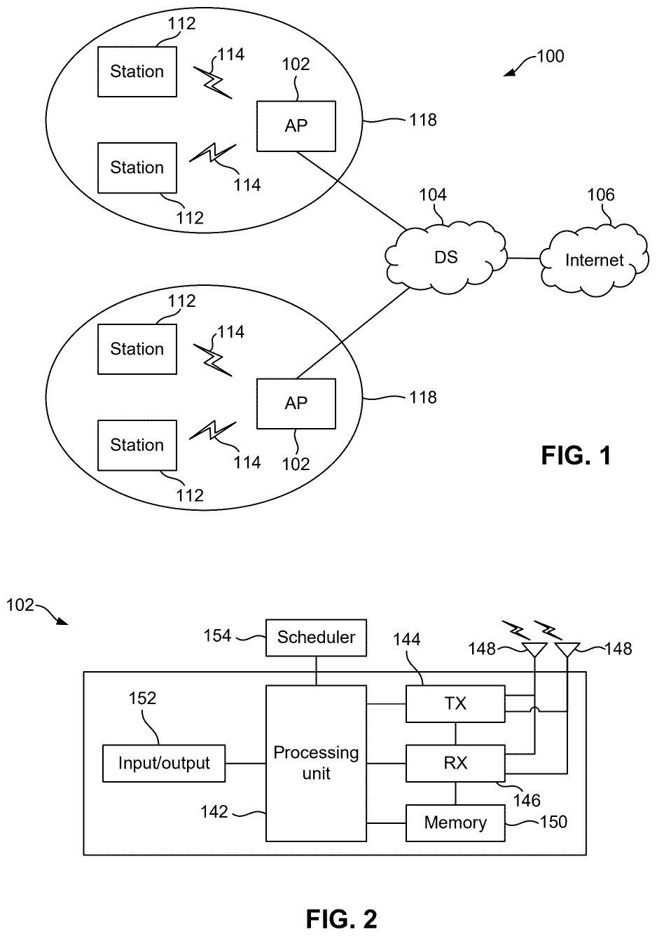

Turning now to FIG. 1, a communication system according to some embodiments of this disclosure is shown and is generally identified using reference numeral 100. As an example, the communication system 100 may be a WI-FI® system built under relevant standards such as IEEE 802.11 standard. As shown, the communication system 100 comprises a plurality of interconnected networking devices 102 such as a plurality of interconnected access points (APs; also called “base stations”) forming a distribution system (DS) 104 which is in turn connected to other networks such as the Internet 108 which may include a network of computers and subnets (intranets) or both, and incorporate protocols, such as Internet Protocol (IP), Transmission Control Protocol (TCP), User Datagram Protocol (UDP), and/or the like.

Each AP 102 is in wireless communication with one or more mobile or stationary stations 112 (STAs) through respective wireless channels 114 for providing wireless network connects thereto. Herein, the APs 102 and STAs 112 may be considered as different types of network nodes (or simply “nodes”) of the communication system 100. Each AP 102 and the STAs 112 connected thereto form a cell or Basic Service Set (BSS) 118.

FIG. 2 is a simplified schematic diagram of an AP 102. As shown, the AP 102 comprises at least one processing unit 142 (also denoted at least one “processor”), at least one transmitter (TX; also denoting “transmission”) 144, at least one receiver (RX; also denoting “receiving”) 146 (collectively referred to as a transceiver), one or more antennas 148, at least one memory 150, and one or more input/output components or interfaces 152. A scheduler 154 may be coupled to the processing unit 142. The scheduler 154 may be included within or operated separately from the AP 102. Each of these components 142 to 154 may be implemented as one or more circuits (such as one or more electronic circuits and/or one or more optical circuits). Alternatively, the ensemble of these components 142 to 154 may be implemented as one or more circuits.

The processing unit 142 Is configured for performing various processing operations such as signal coding, data processing, power control, input/output processing, or any other suitable functionalities. The processing unit 142 may comprise a microprocessor, a microcontroller, a digital signal processor, a FPGA, an ASIC, and/or the like. In some embodiments, the processing unit 142 may execute computer-executable instructions or code stored in the memory 150 to perform various the procedures (otherwise referred to as methods) described below.

Each transmitter 144 may comprise any suitable structure for generating signals, such as control signals as described in detail below, for wireless transmission to one or more STAs 112. Each receiver 146 may comprise any suitable structure for processing signals received wirelessly from one or more STAs 112. Although shown as separate components, at least one transmitter 144 and at least one receiver 146 may be integrated and implemented as a transceiver. Each antenna 148 may comprise any suitable structure for transmitting and/or receiving wireless signals. Although common antennas 148 are shown in FIG. 2 as being coupled to both the transmitter 144 and the receiver 146, one or more antennas 148 may be coupled to the transmitter 144, and one or more other antennas 148 may be coupled to the receiver 146.

In some embodiments, an AP 102 may comprise a plurality of transmitters 144 and receivers 146 (or a plurality of transceivers) together with a plurality of antennas 148 for communication in its cell 118.

Each memory 150 may comprise any suitable volatile and/or non-volatile storage such as RAM, ROM, hard disk, optical disc, SIM card, solid-state memory, memory stick, SD memory card, and/or the like. The memory 150 may be used for storing instructions executable by the processing unit 142 and data used, generated, or collected by the processing unit 142.

For example, the memory 150 may store instructions of software, software systems, or software modules that are executable by the processing unit 142 for implementing some or all of the functionalities and/or embodiments of the procedures performed by an AP 102 described herein.

Each input/output component 152 enables interaction with a user or other devices in the communication system 100. Each input/output device 152 may comprise any suitable structure for providing information to or receiving information from a user and may be, for example, a speaker, a microphone, a keypad, a keyboard, a display, a touch screen, a network communication interface, and/or the like.

Herein, the STAs 112 may be any suitable wireless device that may join the communication system 100 via an AP 102 for wireless operation. In various embodiments, a STA 112 may be a wireless electronic device used by a human or user (such as a smartphone, a cellphone, a personal digital assistant (PDA), a laptop, a desktop computer, a tablet, a smart watch, a consumer electronics device, and/or the like). A STA 112 may alternatively be a wireless sensor, an Internet-of-Things (IoT) device, a robot, a shopping cart, a vehicle, a smart TV, a smart appliance, a wireless transmit/receive unit (WTRU), a mobile station, or the like. Depending on the implementation, the STA 112 may be movable autonomously or under the direct or remote control of a human, or may be positioned at a fixed position.

In some embodiments, a STA 112 may be a multimode wireless electronic device capable of operation according to multiple radio access technologies and incorporate multiple transceivers necessary to support such.

In addition, some or all of the STAs 112 comprise functionality for communicating with different wireless devices and/or wireless networks via different wireless links using different wireless technologies and/or protocols. Instead of wireless communication (or in addition thereto), the STAs 112 may communicate via wired communication channels to other devices or switches (not shown), and to the Internet 106. For example, a plurality of STAs 112 (such as STAs 112 in proximity with each other) may communicate with each other directly via suitable wired or wireless sidelinks.

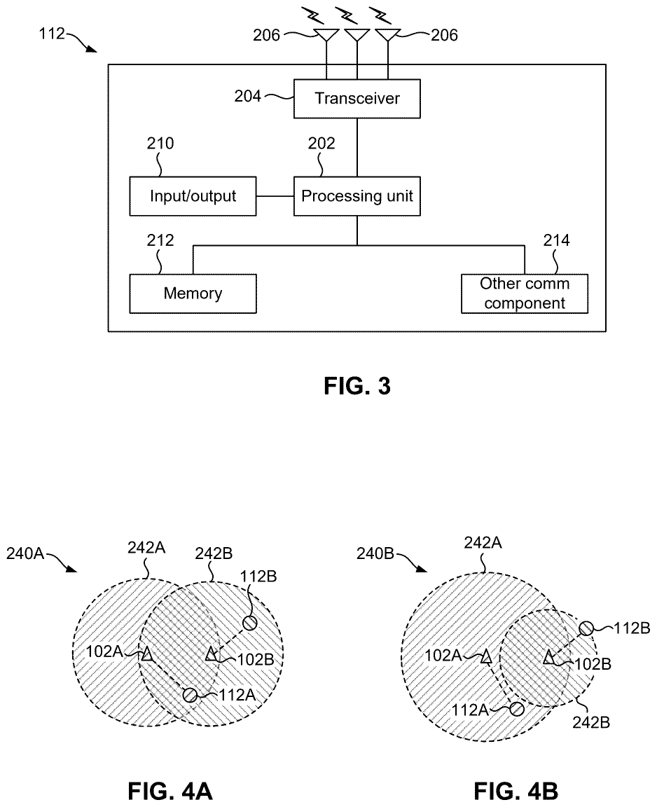

FIG. 3 is a simplified schematic diagram of a STA 112. As shown, the STA 112 comprises at least one processing unit 202, at least one transceiver 204, at least one antenna or network interface controller (NIC) 206, one or more input/output components 210, at least one memory 212, and at least one other communication component 214. Each of these components 202 to 214 may be implemented as one or more circuits (such as one or more electronic circuits and/or one or more optical circuits). Alternatively, the ensemble of these components 202 to 214 may be implemented as one or more circuits. In various embodiments, the STA 112 may also comprise other components as needed or as desired.

The processing unit 202 is configured for performing various processing operations such as signal coding, data processing, power control, input/output processing, or any other functionalities to enable the STA 112 to access and join the communication system 100 and operate therein. The processing unit 202 may also be configured to implement some or all of the functionalities of the STA 112 described in this disclosure. The processing unit 202 may comprise a central processing unit (CPU), a microprocessor, a microcontroller, a digital signal processor, an accelerator, a graphic processing unit (GPU), a tensor processing unit (TPU), a FPGA, or an ASIC. Examples of the processing unit 202 may be an ARM® microprocessor (ARM is a registered trademark of Arm Ltd., Cambridge, UK) manufactured by a variety of manufactures such as Qualcomm of San Diego, California, USA, under the ARM® architecture, an INTEL® microprocessor (INTEL is a registered trademark of Intel Corp., Santa Clara, CA, USA), an AMD® microprocessor (AMD is a registered trademark of Advanced Micro Devices Inc., Sunnyvale, CA, USA), and the like. In some embodiments, the processing unit 202 may execute computer-executable instructions or code stored in the memory 212 to perform various processes described below.

The at least one transceiver 204 may be configured for modulating data or other content for transmission by the at least one antenna 206 to communicate with an AP 102. The transceiver 204 is also configured for demodulating data or other content received by the at least one antenna 206. Each transceiver 204 may comprise any suitable structure for generating signals for wireless transmission and/or processing signals received wirelessly. Each antenna 206 may comprise any suitable structure for transmitting and/or receiving wireless signals. Although shown as a single functional unit, a transceiver 204 may be implemented separately as at least one transmitter and at least one receiver.

The one or more input/output components 210 is configured for interaction with a user or other devices in the communication system 100. Each input/output component 210 may comprise any suitable structure for providing information to or receiving information from a user and may be, for example, a speaker, a microphone, a keypad, a keyboard, a display, a touch screen, and/or the like.

The at least one memory 212 is configured for storing instructions executable by the processing unit 202 and data used, generated, or collected by the processing unit 202. For example, the memory 212 may store instructions of software, software systems, or software modules that are executable by the processing unit 202 for implementing some or all of the functionalities and/or embodiments of the STA 112 described herein. Each memory 212 may comprise any suitable volatile and/or non-volatile storage and retrieval components such as RAM, ROM, hard disk, optical disc, SIM card, solid-state memory modules, memory stick, SD memory card, and/or the like.

The at least one other communication component 214 is configured for communicating with other devices such as other STAs 112 via other communication means such as a radio link, a BLUETOOTH® link (BLUETOOTH is a registered trademark of Bluetooth Sig Inc., Kirkland, WA, USA), a wired sidelink, and/or the like. Examples of the wired sidelink may be a USB cable, a network cable, a parallel cable, a serial cable, and/or the like.

In some embodiments, a STA 112 may comprise a plurality of transceivers 204 and a plurality of antennas 206 for communication with an AP 102.

In the communication between the AP 102 and the STA 112, a transmission from the STA 112 to the AP 102 is usually denoted an uplink (UL) and the wireless channel used therefor is denoted an uplink channel. A transmission from the AP 102 to the STA 112 is usually denoted a downlink (DL) and the wireless channel used therefor is denoted a downlink channel.

In physical layer, the frequency-time resource of the channel 114 is partitioned into Physical Layer Protocol Data Units (PPDUs; also called “packets”), and the AP 102 or STA 112 transmits data as PPDUs or packets. Suitable modulation technologies may be used for communication between the AP 102 and the STA 112. For example, in some embodiments, Orthogonal Frequency-Division Multiplexing (OFDM) may be used wherein the channel 114 is composed of a plurality orthogonal subcarriers for communication between the AP 102 and the STA 112. Moreover, as there are usually a plurality of STAs 112 in communication with a same AP 102, suitable multiple-access technologies may be used. For example, in some embodiments, Orthogonal Frequency-Division Multiple Access (OFDMA) may be used for communication between the AP 102 and STAs 112.

### B. Coordinated Spatial Reuse and Dynamic Sub-Band Operations for Multi-Access-Points

As those skilled in the art understand, in traditional WI-FI® networks, APs 102 operate independently, which can lead to issues such as Overlapping Basic Service Set (OBSS) interference, suboptimal resource allocation, inconsistent user experiences (especially as network density increases), and/or the like.

Multi-AP (MAP) coordination aims at enhancing network efficiency and user experience in environments with multiple APs 102, such as WI-FI® networks in densely populated areas.

The UHR specifications defines a common framework for MAP coordination, allowing for the implementation of various coordination schemes. By allowing APs 102 to work together, network performance can be significantly improved, ensuring a smoother, faster, and more reliable experience for users. Through this coordinated effort, APs 102 can optimize channel usage, mitigate OBSS interference, and manage resources such as bandwidth and transmission power. Techniques, such as coordinated spatial reuse (CSR), coordinated beamforming (Co-BF), coordinated time division multiple access (Co-TDMA), and coordinated restricted-target wake time (Co-RTWT), provide more effective spectrum sharing, reduced OBSS interference and latency, and improved system throughput.

MAP coordination is particularly valuable in environments where users are constantly moving, such as in offices, shopping malls, and smart homes, where seamless handoffs and robust connectivity are essential. In addition to defining coordination schemes, the IEEE 802.11bn framework supports essential procedures such as MAP coordination discovery and agreement negotiation. These procedures ensure that APs 102 within OBSSs can coordinate efficiently, although the specifics of whether these procedures will be mandatory or optional are yet to be determined.

According to the UHR specifications, CSR at the Transmission Opportunity (TXOP) level with power control is a prominent example of MAP coordination, aiming to improve the efficiency and capacity of WI-FI® networks by optimizing the use of the radio spectrum. Traditional WI-FI® networks suffer from OBSS interference and inefficient spectrum usage, especially in dense environments with multiple APs 102 and devices operating in proximity.

CSR addresses these challenges by enabling APs 102 to cooperatively share the spectrum and reuse the same frequency channel simultaneously more effectively, even within overlapping coverage areas, while minimizing OBSS interference through coordination by deploying transmit power control mechanisms.

The gains from CSR primarily come from effective TX power management. There are two main approaches to managing transmit power in CSR. FIGS. 4A and 4B are schematic diagrams showing examples of the two approaches, each of which shows a TXOP sharing AP 102A and a shared AP 102B communicating with STAs 112A and 112B, respectively. Herein, a TXOP sharing AP refers to an AP that gains a TXOP and shares transmission resources such as frequency or time with another AP, which is denoted a shared AP. Generally, an AP 102 may initiate a TXOP for itself or grant it to a specific STA 112, allowing that STA 112 to transmit data without having to contend for the channel for the duration of the TXOP. In these embodiments, the sharing AP 102A obtains a TXOP over a specific channel for a defined duration and shares this TXOP duration on that channel with the shared AP 102B.

As shown in FIG. 4A, the first approach 240A, known as bi-directional coordination, involves negotiation between the TXOP sharing AP 102A and the shared AP 102 to determine the optimal transmit power combination, including the negotiated power 242A for the TXOP sharing AP 102A and the negotiated power 242B for the shared AP 102B.

The bi-directional coordination method 240A uses transmit power control (TPC) for maintaining the performance of the TXOP holder (that is, the TXOP sharing AP 102A).

In traditional spatial reuse protocols, TPC is a critical component that significantly impacts how STAs 112 manage their transmissions in dynamic environments. When the Clear Channel Assessment (CCA) level increases (indicating higher levels of ambient interference), the STA 112 is required to reduce its transmit power by a corresponding amount of decibels. This power adjustment aims to minimize interference with ongoing transmissions, functioning similarly to mechanisms employed in legacy Enhanced Distributed Channel Access (EDCA) protocols.

TPC is also an essential part of the bi-directional coordination method 240A. With the use of TPC, if interference from the shared AP 102B becomes significant, the TXOP holder 102A must make crucial decisions to ensure reliable communication. Specifically, the TXOP holder 102A may need to either reduce the Modulation and Coding Scheme (MCS) of its transmission, thereby decreasing its data rate, or opt not to initiate CSR transmission altogether. This adjustment ensures that both APs 102A and 102B can operate efficiently without compromising performance.

Alternatively, if the target STA 112A of the sharing AP 102A has high Quality of Service (QoS) requirements or if the shared AP 102B is handling a heavier traffic load, the TXOP holder 102A can opt to reduce the power of the shared AP 102B to safeguard its own transmission performance. Ultimately, TPC empowers the TXOP holder 102A to make informed decisions tailored to the network conditions, including the option to forgo initiating CSR if necessary, thereby enhancing overall network reliability and efficiency.

However, while the bi-directional coordination method 240A may improve the overall sum throughput, it comes with additional signaling overhead due to the need for constant negotiation between the APs.

As shown in FIG. 4B, the second approach 240B is one-way coordination without mutual transmit power control. In this method, the TXOP sharing AP 102A independently limits the transmit power of the shared AP 102B to protect its own transmissions.

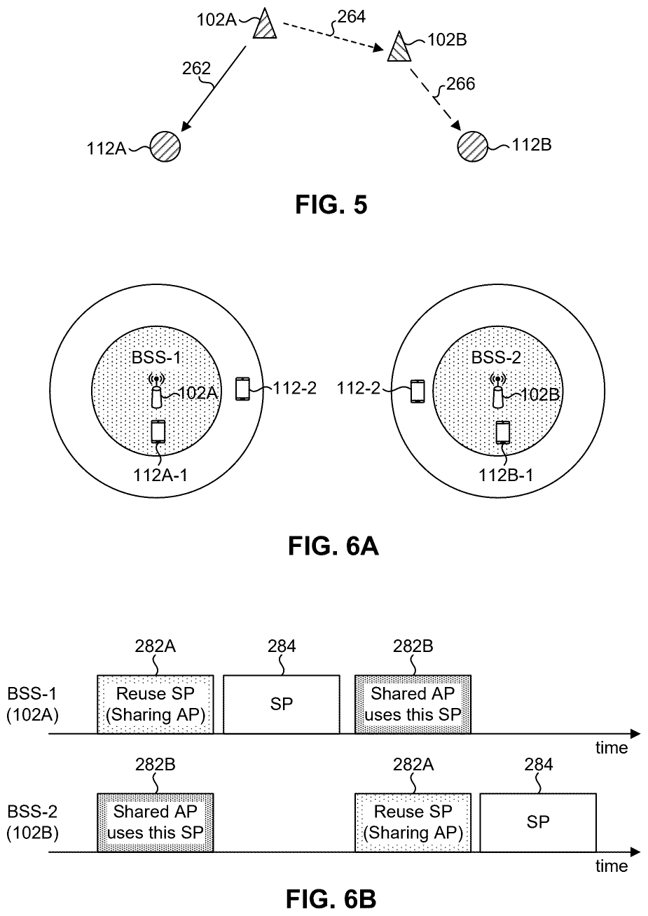

While various CSR methods at the TXOP level with power control are available in prior art, they have similar high-level concept. FIG. 5 shows an example.

As shown, APs 102A and 102B form a CSR group. In this example, AP 102A wins the TXOP, which grants AP 102A the authority to manage the transmission schedule. To initiate the coordinated transmission, AP 102A sends a scheduling frame 264 to AP 102B. This scheduling frame 264 includes essential parameters such as the duration of the CSR and the maximum transmission power that AP 102B is allowed to use during this period. Upon receiving the scheduling frame 264, AP 102B initiates its CSR transmission 266 in accordance with the specified parameters. By adhering to the guidelines set forth by AP 102A, AP 102B can effectively manage its transmission power and timing, ensuring that its communication 266 does not interfere with AP 102A's transmissions 262.

One of the primary concerns associated with TXOP-based CSR is its high computational complexity. This complexity arises from the need for per-TXOP interference measurement and the associated signaling between the TXOP sharing AP 102A and the shared APs 102B. Each time a TXOP is awarded, both the sharing and shared APs 102A and 102B must engage in calculations to assess the interference levels within their operational environment. Additionally, these APs 102A and 102B face challenges related to making scheduling decisions at the last moment. They must quickly evaluate which STAs 112 have been scheduled to receive service, which can lead to time-sensitive decisions that affect the effectiveness of the CSR. This need for rapid assessment and coordination can place significant demands on the processing capabilities of the APs 102 involved.

Moreover, the effectiveness of CSR mechanisms can significantly diminish for cell-edge STAs 112 operating within OBSSs. These cell-edge STAs 112 are typically located at the boundaries of a coverage area and are thus more vulnerable to interference from neighboring APs 102. Due to their geographical position, the cell-edge STAs 112 may experience weaker signal strength and higher levels of co-channel interference, which can degrade their overall performance and reliability. In the context of TXOP-based CSR, the challenges are compounded by the inherent complexities associated with managing transmit power control. While TXOP-based CSR aims to optimize channel usage and minimize interference through coordinated scheduling and power management, these mechanisms may struggle to effectively mitigate the interference experienced by cell-edge STAs 112. The dynamic nature of OBSS environments can lead to fluctuating interference levels that are difficult to predict and manage, especially for devices on the fringe of the coverage area. As a result, cell-edge STAs 112 may not receive the same level of service quality as their counterparts closer to the center of the coverage area. This disparity can lead to suboptimal performance, manifesting as slower data rates, increased latency, and higher packet loss for these vulnerable devices. Therefore, while TXOP-based CSR can significantly enhance coordination and efficiency in certain densely populated environments, it also introduces challenges that must be carefully navigated. To ensure reliable communication and equitable service quality for all connected devices, including those at the cell edge, additional methods may be necessary to address the unique interference issues faced by these STAs 112.

To address the challenges associated with TXOP-based CSR, an alternative service period (SP) based approach has been proposed in prior art, which seeks to balance complexity with potential performance gains. This is particularly relevant in, for example, enterprise environments where a significant proportion of clients are often semi-static, meaning they do not move frequently and maintain relatively stable connections.

Given this context, the idea is to implement coordinated spatial reuse using longer-term signaling mechanisms. Instead of relying on per-TXOP last-minute signaling, which necessitates complex scheduling decisions and rapid interference estimations, this method advocates for the use of a longer-term signaling approach leverages the concept of SPs, which are announced well in advance. By doing so, both sharing AP 102A and shared AP 102B are relieved from the pressures of stringent time constraints regarding scheduling and interference assessment.

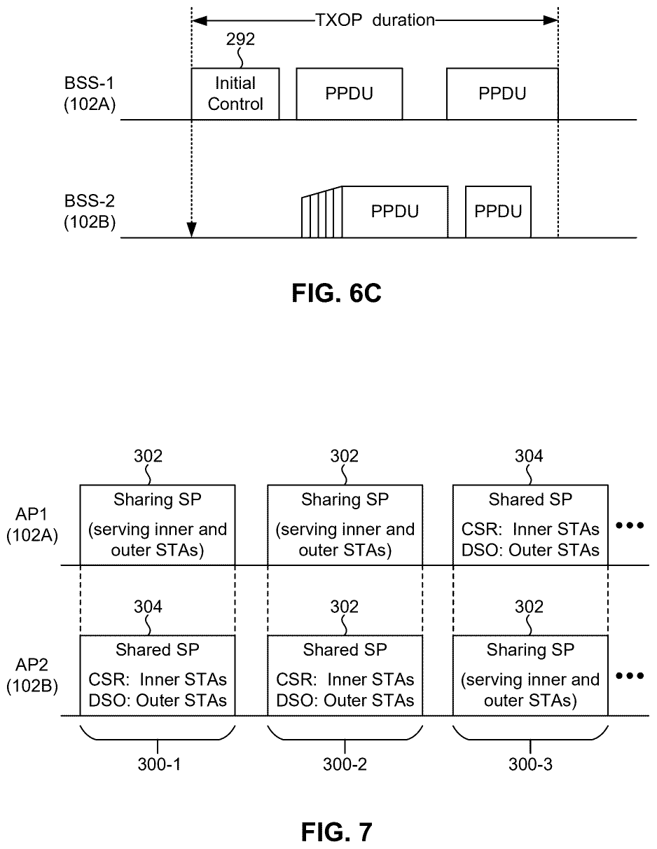

As shown in FIG. 6A, within this strategy, each associating AP 102 (such as APs 102A and 102B shown in FIG. 6A), or more generally, each BSS, classifies its associated STAs 112 into two categories, including the inner STAs 112-1 (such as the inner STAs 112A-1 associated with AP 102A and the inner STAs 112B-1 associated with AP 102B) and the outer STAs 112-2 (such as the outer STAs 112A-2 associated with AP 102A and the outer STAs 112B-2 associated with AP 102B). Inner STAs 112-1 are those experiencing lower levels of interference from neighboring APs, making them suitable candidates for spatial reuse during designated service periods. In contrast, outer STAs 112-2 are subjected to higher interference levels (for example, cell-edge STAs) and will have their service periods structured differently.

As shown in FIG. 6B, two distinct types of SPs, including reuse SPs 282 (such as 282A and 282B shown in FIG. 6B) and orthogonal SPs 284, are scheduled over the long term to optimize network resource management and enhance the performance of connected devices.

Reuse SPs 282 are designed for scenarios where overlapping transmissions can occur without causing significant interference among devices. During these periods, the sharing AP (for example, the AP 102A) and shared AP (for example, the AP 102B) coordinate their efforts to serve only their respective inner non-AP STAs 112-1 which experience lower OBSS interference. The key characteristic of reuse SPs 282 is that multiple APs 102 can transmit simultaneously during the same time window, as long as the transmissions are confined to inner

STAs 112-1. By facilitating concurrent transmissions, reuse SPs 282 maximize the utilization of available spectrum, leading to improved overall network throughput.

In contrast, orthogonal SPs 284 are scheduled to serve outer STAs 112-2 which are typically more susceptible to OBSS interference. During orthogonal SPs 284, APs 102 do not transmit simultaneously; instead, they serve outer STAs 112-2 at different times to minimize overlapping transmissions that could lead to significant interference. This time separation protects outer STAs 112-2 from communication quality degradation due to interference, which is especially important for clients located at the edges of coverage areas. Effective coordination among APs 102 is essential for scheduling orthogonal SPs 284, ensuring clear timing for when each AP 102 will serve its outer STAs 112-2. This coordination can be achieved through longer-term signaling, such as beacons or management frames, allowing APs 102 to communicate their scheduled periods well in advance and reducing the complexity of last-minute decisions.

This approach can be also deployed in an TXOP-basis. As shown in FIG. 6C, once the sharing AP 102A secures the TXOP, it transmits a specific initial control frame (ICF) 292 to initiate a CSR transmission with the shared AP 102B. This ICF includes the CSR group ID or the BSSID of the shared AP 102B. Upon receiving the ICF, the shared AP 102B and its inner STAs 112B-2 can disregard the basic Network Allocation Vector (NAV) established by the ICF and begin the CSR contention. This process is based on a per-TXOP framework, removing the constraints typically associated with designated service periods.

The prior art on CSR scheduling has several significant issues, primarily related to the handling of outer STAs 112-2 (such as those located at the cell edge) and the overall efficiency of resource utilization.

For example, one of the primary issues is the increased delays for outer STAs 112-2 with latency-sensitive applications. In other words, the outer STAs 112-2 must wait for the SP or TXOP of the inner STAs 112-1 to finish, which increases latency for real-time applications, degrading user experience.

More specifically, to mitigate interference in OBSS, outer STAs 112-2 are typically scheduled on separate orthogonal SPs 284 or TXOPs. However, these outer STAs 112-2 must wait for the shared CSR SPs or TXOPs (which are dedicated to inner STAs 112-1) to conclude or finish before their own dedicated periods can begin. This waiting period can introduce substantial delays or latencies, which are especially harmful for applications that rely on real-time data transmission such as video conferencing, voice-over-IP (VOIP), online gaming, and/or the like, thereby degrading user experiences.

Moreover, the isolated scheduling reduces opportunities for concurrent transmissions, which results in inefficient use of bandwidth, decreasing overall network performance.

More specifically, the separation of outer STAs 112-2 in scheduling leads to underutilization of available bandwidth. By isolating outer STAs 112-2 on their own SPs or TXOPs, the simultaneous transmission potential of multiple APs is underexploited. This results in inefficient spectrum use, wasting valuable bandwidth that could be otherwise utilized to improve network throughput, particularly in, for example, high-demand environments like enterprise networks.

Another critical challenge is the complexity in scheduling and interference management. For example, APs 102 must continuously monitor and assess interference levels, which means that dynamic scheduling decisions may add complexity and increase computational overhead.

More specifically, the system requires continuous interference assessment and dynamic adjustments to scheduling, especially for outer STAs 112-2, which places a significant computational burden on the APs, meaning that the APs must perform real-time interference measurement and signaling. The resulting complexity makes the scheduling process less efficient and increases the likelihood of errors in dense or highly dynamic networks.

Moreover, the challenges in managing dynamic interference due to the dynamic movement of STAs 112 within BSS 102 also contribute to this issue. For example, fluctuating interference levels make semi-static STAs' classification inefficient, and outer STAs 112-2 are disproportionately affected by inconsistent interference management.

More specifically, since interference levels fluctuate in real-world wireless environments, static classification and scheduling of outer STAs 112-2 on separate SPs or TXOPs can fail to adapt to changing conditions. This results in inconsistent performance, especially for outer STAs 112-2, thereby further compounding their vulnerability to interference.

Thus, the existing CSR methods face several challenges related to delay, resource underutilization, and increased complexity, which disproportionately affect cell-edge STAs 112. These issues highlight the need for alternative strategies that balance performance and complexity, ensuring better service quality for all STAs 112, including those at the cell edge.

In the following, various embodiments of enhanced CSR methods are described. By using the enhanced CSR methods disclosed herein, the sharing AP 102A and/or shared AP 102B may respectively serve their STAs 112A (including inner and outer STAs 112A-1 and 112A-2) and simultaneously during the shared TXOP/SP over their primary channels or by serving their inner STAs 112A-1 and 112B-1 on their primary channels and their outer STAs 112A-2 and 112B-2 on their pre-defined or predetermined DSO channels located within the sharing AP's and shared AP's operating bandwidths.

The enhanced CSR methods disclosed herein uses dynamic sub-band operation (DSO) channel. In prior art, DSO allows dynamic adjustment of sub-band utilization within a channel based on factors such as interference, traffic load, environmental conditions, and/or the like, thereby enhancing spectral efficiency and improve overall network performance. More specifically, by using DSO, an AP 102 may utilize a secondary channel (that is, a DSO channel) bandwidth when it wins channel access in a dynamic matter on a per-TXOP basis. The AP 102 may dynamically decide whether to allocate a STA 112 on the primary channel or the DSO channel based on bandwidth availability and QoS parameters or requirements.

In the embodiments disclosed herein, instead of scheduling outer STAs 112B-2 on separate orthogonal SPs 284 or TXOPs, the shared AP 102B within the CSR group allows outer STAs 112B-2 to transmit during the shared CSR SPs or TXOPs. This is achieved by triggering the outer STAs 112B-2 to switch to a pre-defined DSO channel located within the shared AP's operating bandwidth.

At the end of the shared CSR SP or TXOP, the outer STAs 112B-2 may either return to their primary channel or remain on the DSO channel for an extended period, as determined by their associating AP 102B. The associating AP 102B may decide that one or more outer STAs 112B-2 stay extended time over the DSO channel to compensates for any time lost due to the DSO channel switching delay, which varies based on the DSO channel location and the operating bandwidth of the one or more outer STAs 112B-2.

This approach eliminates the need for separate scheduling by multiple APs (for example, AP 102A and AP 102B) for outer STAs 112B-2 on orthogonal SP 284 or TXOPs. It allows for more efficient use of available bandwidth by enabling the inner and outer STAs 112B-1 and 112B-2 of the shared AP 102B in OBSSs to transmit simultaneously within the same CSR SP or TXOP.

The enhanced CSR methods disclosed herein may be used for both SP-based and TXOP-based CSR. Moreover, the enhanced CSR methods disclosed herein incorporate various inner and outer STAs classification criteria that adapt with the dynamic change with WI-FI® network environment and STAs' mobility.

In some embodiments, an enhanced SP-CSR method employing DSO or enhanced subchannel selective transmission (SST) may be used. DSO operations can be supported in SP-basis through utilizing an enhanced SST protocol (described in more detail later). According to this method, APs 102 such as AP 102A and AP 102B within a CSR group pre-determine their inner STAs 112-1 and outer STAs 112-2 on a semi-static basis.

For example, each AP 102 within the CSR group may determine its inner/outer STAs 112-1 and 112-2 based on its STA's reporting of beacon power from neighboring interfering APs that is measured periodically.

Then, APs 102 within the CSR group coordinate the maximum transmit power for both the sharing AP (such as AP 102A) and its associated STAs 112, as well as for the shared AP (such as AP 102B) and its inner STAs (such as STAs 112B-1). APs 102 within the CSR group also negotiate the DSO channel location and bandwidth to be used by the outer STAs 112B-2 of the shared AP 102B, and report the maximum DSO switching delay within each BSS 102 accordingly, along with key SP parameters such as start times, durations, intervals, and/or the like.

As an example, FIG. shows two APs 102A and 102B using the enhanced SP-CSR method employing DSO three times, wherein in the first and second times 300-1 and 300-2, AP 102A acts as the sharing AP and AP 102B acts as the shared AP. In the third time 300-3, AP 102B acts as the sharing AP and AP 102A acts as the shared AP.

Using the first time 300-1 as an example, once the sharing AP 102A and shared AP 102B agree upon the CSR arrangement such as the CSR, DSO, and SP parameters (for example, the maximum UL/DL transmit power values of the CSR channels within P160, the location and bandwidth of the DSO channel within S160, and the SP duration and the interval between two successive SPs), the sharing AP 102A broadcasts a portion of the CSR arrangement as needed (for example, without the DSO-related information) in one broadcast target wake time (TWT) agreement 302 (also denoted a “TWT element”), for example, in a beacon frame, to all its associated STAs 112A. As those skilled in the art understand, a TWT agreement between an AP 102 and a STA 112 associated therewith defines when the STA 112 in the doze state (in which the STA 112 is generally in the power-saving mode) needs to “wake up” at agreed times to receive and send data.

The shared AP 102B also broadcasts these parameters in two aligned trigger-based broadcast TWT agreements 304, including a TWT agreement for CSR-supported inner STAs 112B-1 and another TWT agreement for DSO-supported outer STAs 112B-2, for example, in a beacon frame to all its associated STAs 112A.

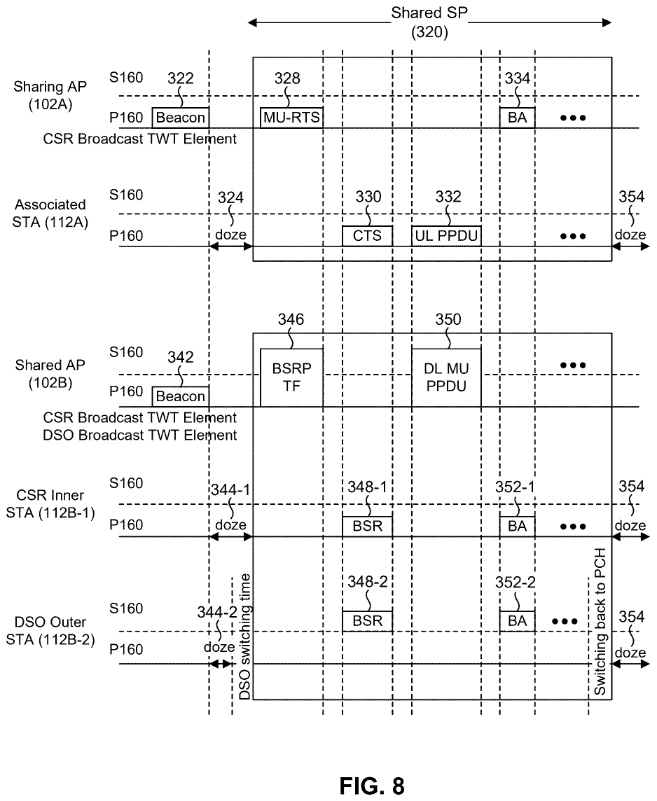

FIG. 8 is a timing diagram showing an example of the details of operations within the shared SP 320 between the sharing AP 102A and the shared AP 102B, according to some embodiments of this disclosure. In this example, the operating BW of each AP 102A or 102B is 320 megahertz (MHz), which is partitioned into two 160 MHz bands P160 and S160. As will be described in more detail below, each STA 112B of the shared AP 102B operates either over a primary channel (for example, with a BW of 20 MHz) within P160, or a secondary, DSO channel (for example, with a BW of 20 MHz) within S160.

As shown, once the sharing AP 102A and shared AP 102B agree upon the CSR, DSO, and SP parameters, the sharing AP 102A broadcasts its SP parameters to its associated STAs 112A using a conventional CSR broadcast TWT element (described in more detail later) included in a beacon frame 322 through the primary channel located within P160.

Once the STAs 112A associated with the sharing AP 102A receive the beacon frame 322 and know their SP scheduling, they go in the doze state 324 and wake-up at the SP start time.

The communications between the sharing AP 102A and its associated STAs 112A may be conducted through the primary channel located within P160 in the conventional manner. For example, during the shared SP 320, the sharing AP 102A may perform its normal UL/DL operations over its SP, for example, sending a trigger frame 328 (such as a multi-user (MU) request-to-send (MU-RTS) trigger frame, a buffer status report poll trigger frame (BSRP TF), a basic trigger frame, a multi-user block acknowledgement (ACK) request (MU-BAR) trigger frame, a Multi-STA block ACK (Multi-STA BA), or the like) to its associated STAs 112A, and then conducting communications therebetween using their maximum transmit power or by following the CSR transmit power control rules by limiting their transmit power or adjust their MCS. In the example shown in FIG. 8, after wakeup, the STA 112A sends a clear-to-send (CTS) frame 330 to the sharing AP 102A followed by a UL PPDU 332. After receiving the UL PPDU 332, the sharing AP 102A responds with a block ACK (BA) 334.

Meanwhile, the shared AP 102B broadcasts the SP parameters to its associated STAs 112B in two aligned trigger-based broadcast TWT agreements (including one (denoted “CSR Broadcast TWT Element”) for CSR-supported inner STAs 112B-1 and another (denoted “DSO or enhanced SST Broadcast TWT Element”) for DSO-supported outer STAs 112B-2) in a beacon frame or action frame 342 through the primary channel located within P160.

Once the STAs 112B of the shared AP 102B receive the beacon frame 342 and know their SP scheduling, they go in the doze state 344 (shown as 344-1 for the inner STAs 112B-1 and 344-2 for the outer STAs 112B-2 in FIG. 8).

The inner STAs 112B-1 of the shared AP 102B wake up at the start of the shared SP 320, and then follow the CSR transmission rules listed in the CSR broadcast TWT element.

Each outer STA 112B-2 of the shared AP 102B may wake up and switch to its DSO channel located within S160 slightly earlier (represented by the shorter doze 344-2) to account for the DSO channel switching delay, which varies depending on its operating bandwidth capability. This ensures that the DSO channel switch is completed before the start of the SP 320. For uplink transmissions on the DSO channel, the outer non-AP STA can transmit at its maximum power, as it no longer causes or experiences OBSS interference.

In communications with its associated STAs 112B, the shared AP 102B follows the CSR rules in terms of the transmit power and MCS level as agreed with the sharing AP 102A during its downlink transmission.

For example, at the start of the shared SP 320, the shared AP 102B sends a trigger frame 346 (such as a MU-RTS trigger frame, a BSRP TF, a basic trigger frame, a MU-BAR trigger frame, a Multi-STA BA, or the like) to its STAs 112B using both the primary channel located within P160 and the DSO channel located within S160 (that is, this trigger frame is duplicated over all the supported channels by the shared AP 102B) to confirm the awake status of associated STAs 112B and the subchannel on which the inner and outer STAs 112B-1 and 112B-2 stay.

The inner STAs 112B-1 of the shared AP 102B respond to the shared AP's trigger frame 346 by sending a buffer status report (BSR) 348-1 through the primary channel located within P160 following the CSR rules. The outer STAs 112B-2 of the shared AP 102B respond to the shared AP's trigger frame 346 by sending a BSR 348-2 through the DSO channel located within S160.

Then, the shared AP 102B may send a DL MU PPDU 350 to its associated STAs 112B using both the primary channel located within P160 and the DSO channel located within S160. After receiving the DL MU PPDU 350, the inner STAs 112B-1 respond with a BA 352-1 via the primary channel located within P160, and the outer STAs 112B-2 respond with a BA 352-2 via the DSO channel located within S160.

The above-described communication may repeat until the shared SP 320 ends, at which time the outer STAs 112B-2 switch back to the primary channel (PCH) located within P160. Of course, after the shared SP 320 ends, the STAs 112 may go in the doze state 354.

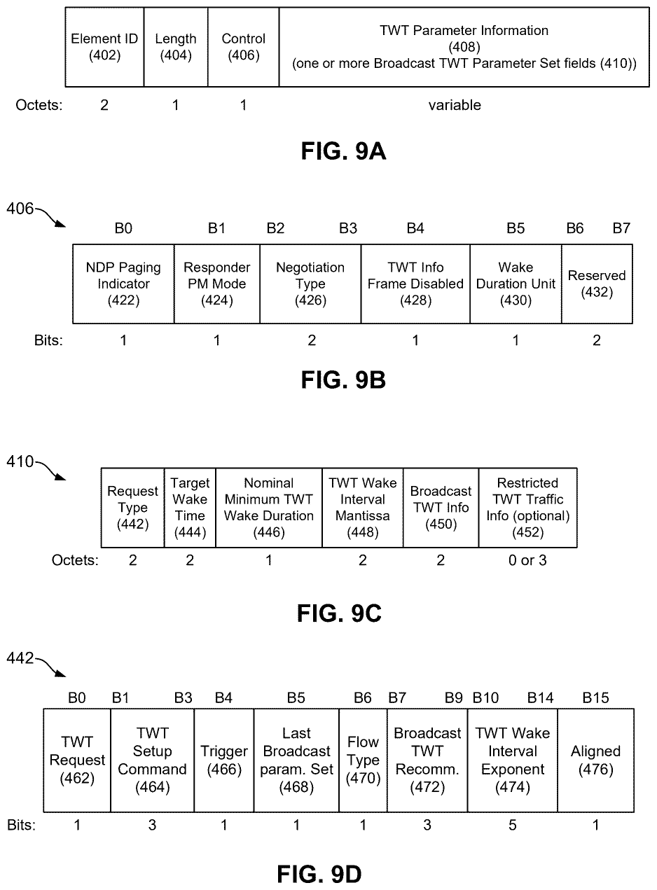

As shown in FIG. 9A, the conventional broadcast TWT signaling format (that is, the format of the broadcast TWT element) comprises an Element ID field 402, a Length field 404, a Control field 406, and a TWT Parameter Information field 408 having one or more TWT Parameter Set fields 410).

As shown in FIG. 9B, the Control field 406 comprises a Null Data Packet (NDP) Paging indicator field 422, a Responder PM Mode field 424, a Negotiation Type field 426, a TWT Information Frame Disabled field 428, a Wake Duration Unit field 430, and a Reserved field 432.

The Negotiation Type field 426 is set to one (1), indicating that the TWT element is a broadcast TWT element. The TWT Parameter Information field 408 comprises a plurality of TWT Parameter Set fields 410 (also denoted “Broadcast TWT Parameter Set fields” in broadcast TWT elements).

As shown in FIG. 9C, each Broadcast TWT Parameter Set field 410 comprises a Request Type field 442, a Target Wake Time field 444, a Nominal Minimum TWT Wake Duration field 446, a TWT Wake Interval Mantissa field 448, a Broadcast TWT Information field 450, and an optional Restricted TWT Traffic Information field 452.

As shown in FIG. 9D, the Request Type field 442 comprises a TWT Request field 462, a TWT Setup Command field 464, a Trigger field 466, a Last Broadcast Parameter Set field 468, a Flow Type field 470, a Broadcast TWT Recommendation field 472, a TWT Wake Interval Exponent field 474, and an Aligned field 476.

As described above, the shared AP 102B broadcasts two aligned broadcast TWT elements (including a CSR broadcast TWT element and a DSO or enhanced SST broadcast TWT element) via the beacon 342. In some embodiments, the trigger-based CSR and DSO/enhanced SST broadcast TWT elements broadcasted by the shared AP 102B may be modified from the conventional broadcast TWT element format.

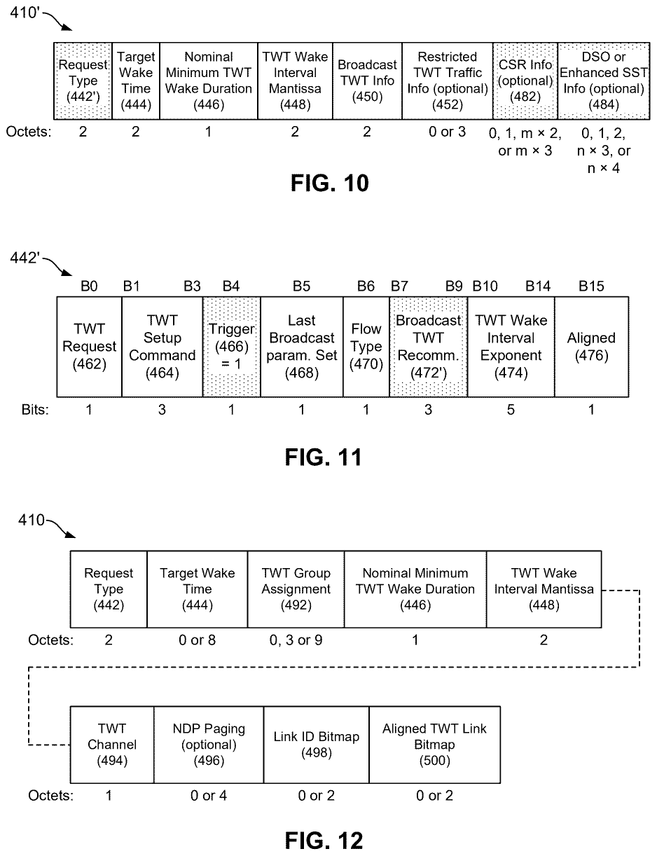

More specifically, as shown in FIG. 10, the modified Broadcast TWT Parameter Set field 410′ of the CSR broadcast TWT or DSO/enhanced SST broadcast TWT element in these embodiments is modified from the Broadcast TWT Parameter Set field 410 of the conventional TWT element with a modified Request Type field 442′ and the appending of an optional CSR information field 482 for indicating the CSR parameters, and an optional DSO or Enhanced SST Information field 484 for indicating the DSO or enhanced SST parameters (described in more detail later).

As shown in FIG. 11, in the modified Request Type field 442′ of the CSR broadcast TWT or DSO broadcast TWT element, the Trigger field 466 is set to one (1) to support trigger-enabled broadcast TWT.

The modified Request Type field 442′ of the CSR broadcast TWT or DSO/enhanced SST broadcast TWT element also comprises a modified Broadcast TWT Recommendation field 472′ modified from the Broadcast TWT Recommendation field 472 of the conventional TWT element. More specifically, in P802.11be/D7.0, values 5 to 7 of the Broadcast TWT Recommendation field 472 are reserved. As shown in Table 1, in these embodiments, values 5 to 7 of the modified Broadcast TWT Recommendation field 472′ are defined as:
five (5): indicating that the corresponding broadcast TWT SP is referred to as an CSR-TWT SP (that is, the CSR broadcast TWT element (denoted “(B-TWT 1” in Table 1) for inner STAs 112B-1);
six (6): indicating that the corresponding broadcast TWT SP is referred to as an DSO-TWT SP (that is the DSO or enhanced SST TWT element (denoted “(B-TWT 2” in Table 1) for outer STAs 112B-2); and
seven (7): reserved.

Values zero (0) to four (4) of the modified Broadcast TWT Recommendation field 472′ are the same as those of the conventional Broadcast TWT Recommendation field 472.

TABLE 1
Modified Broadcast TWT Recommendation field

| Broadcast TWT | Description when |
|---|---|
| Recommendation | transmitted in a |
| field value | broadcast TWT element |
| . . . | . . . |
| 5 | The corresponding broadcast TWT SP is referred to as |
| | an CSR-TWT SP |
| | (B-TWT 1 for inner STAs) |
| 6 | The corresponding broadcast TWT SP is referred to as |
| | an DSO-TWT SP or Enhanced SST-TWT SP |
| | (B-TWT 2 for outer STAs) |
| 7 | Reserved |

In prior art, the SST protocol developed in IEEE 802.11ax is not supported in secondary 160 MHz. Additionally, it is supported only through the individual TWT element through the TWT Channel field (having a length of one octet (that is, 8 bits)) of the Individual TWT Parameter Set field of the individual TWT element, wherein the individual TWT element has a structure similar to that shown in FIG. 9A, and the structure of the Individual TWT Parameter Set field 410 thereof is shown in FIG. 12.

As shown, the prior-art Individual TWT Parameter Set field 410 comprises a Request Type field 442 of two (2) octets, a Target Wake Time field 444 of zero (0) or eight (8) octets, a TWT Group Assignment field 492 of zero (0), three (3), or nine (9) octets, a Nominal Minimum TWT Wake Duration field 446 of one (1) octet, a TWT Wake Interval Mantissa field 448 of two (2) octets, a TWT Channel field 494 of one (1) octet, a NDP Paging field 496 of zero (0) or four (4) octet, a Link ID Bitmap field 498 of zero (0) or two (2) octets, and a Aligned TWT Link Bitmap field 500 of zero (0) or two (2) octets.

In some embodiments, an enhanced SST protocol (also denoted a “modified SST protocol”) may be used for enabling SST to support operations in S160. In some embodiments, the enhanced SST protocol may be included in the Broadcast TWT element.

For example, in some embodiments, the Broadcast TWT element comprises TWT channel information for enhancing the SST protocol to enable channel switching within the secondary 160 MHz.

In some embodiments, all outer STAs 112B-2 switch to the same DSO channel. Then, the TWT Parameter Information field 408 of the TWT element may comprise a single TWT Parameter Set field 410 with a structure shown in, for example, FIG. 10.

In these embodiments, the DSO or Enhanced SST Information field 484 comprises a modified TWT Channel field 494′ modified from the prior-art TWT Channel field 494 using various approaches for indicating the DSO channel information.

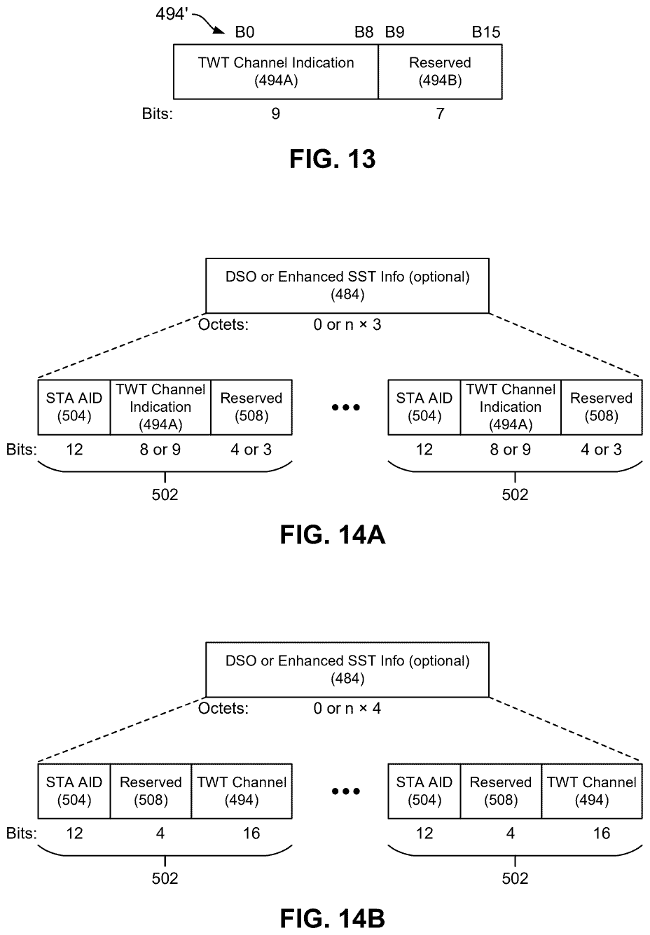

For example, in a first approach, the TWT Channel field 494′ may be extended to two octets, wherein as shown in FIG. 13, the first nine (9) bits are used as a TWT Channel Indication field 494A (which may also be denoted a “TWT Channel field 494A” for simplicity) for indicating the DSO channel information, and the rest seven (7) bits 494B are reserved. Among the nine (9) bits of the TWT Channel Indication field 494A, the first bit B0 indicates the channel location as either in P160 or in S160 (for example, B0=0 indicating P160 and B0=1 indicating S160).

Each subsequent bit represents a specific 20 MHz segment within the 160 MHz band (being P160 or S160), for example,
B1=1 indicating that the DSO channel is the first (lowest) 20 MHz segment of the 160 MHz band,
B2=1 indicating that the DSO channel is the second lowest 20 MHz segment,
B3=1 indicating that the DSO channel is the third lowest 20 MHz segment,
B4=1 indicating that the DSO channel is the fourth lowest 20 MHz segment,
B5=1 indicating that the DSO channel is the fifth lowest 20 MHz segment,
B6=1 indicating that the DSO channel is the sixth lowest 20 MHz segment,
B7=1 indicating that the DSO channel is the seventh lowest 20 MHz segment, and
B8=1 indicating that the DSO channel is the highest 20 MHz segment.

Another approach, the TWT Channel field 494′ may be extended to two octets, wherein all sixteen (16) bits are used as a TWT Channel Indication field (which may also be denoted a “TWT Channel field” for simplicity) for indicating the DSO channel information.

Each of the sixteen (16) bits represents a specific 20 MHz segment within the 320 MHz band, for example,
B0=1 indicating that the DSO channel is the first (lowest) 20 MHz segment of the 320 MHz band,
B1=1 indicating that the DSO channel is the second lowest 20 MHz segment,
B2=1 indicating that the DSO channel is the third lowest 20 MHz segment,
B3=1 indicating that the DSO channel is the fourth lowest 20 MHz segment,
B4=1 indicating that the DSO channel is the fifth lowest 20 MHz segment,
B5=1 indicating that the DSO channel is the sixth lowest 20 MHz segment,
B6=1 indicating that the DSO channel is the seventh lowest 20 MHz segment,
B7=1 indicating that the DSO channel is the eighth lowest 20 MHz segment,
B8=1 indicating that the DSO channel is the ninth lowest 20 MHz segment,
B9=1 indicating that the DSO channel is the tenth lowest 20 MHz segment,
B10=1 indicating that the DSO channel is the eleventh lowest 20 MHz segment,
B11=1 indicating that the DSO channel is the twelfth lowest 20 MHz segment,
B12=1 indicating that the DSO channel is the thirteenth lowest 20 MHz segment,
B13=1 indicating that the DSO channel is the fourteenth lowest 20 MHz segment,
B14=1 indicating that the DSO channel is the fifteenth lowest 20 MHz segment, and
B15=1 indicating that the DSO channel is the highest 20 MHz segment.

A third approach to enhance the SST protocol is to keep the modified TWT Channel field 494′ as a single octet (that is, same as in prior art), and define each bit, for example, as follows:
B0 indicates that the DSO channel is within the primary 80 MHz sub-band (denoted P80) of the 160 MHz P160 band,
B1 indicates that the DSO channel is within the secondary 80 MHz sub-band (denoted S80) of the 160 MHz P160 band,
B2 indicates that the DSO channel is within the P80 of the 160 MHz S160 band, and
B3 indicates that the DSO channel is within the S80 of the 160 MHz S160 band.

Bits B4 to B7 then represent the specific 20 MHz segment within the 80 MHz sub-band indicated by B0 to B3, for example:
B4 indicates that the DSO channel is the lowest 20 MHz segment of the 80 MHz sub-band,
B5 indicates that the DSO channel is the second lowest 20 MHz segment of the 80 MHz sub-band,
B6 indicates that the DSO channel is the third lowest 20 MHz segment of the 80 MHz sub-band, and
B7 indicates that the DSO channel is the highest 20 MHz segment of the 80 MHz sub-band.

This definition allows B0 to B3 to identify the 80 MHz sub-band location, while B4 to B7 indicate the exact 20 MHz channel within that sub-band. Alternatively, the definition of B0-B3 and the definition of B4-B7 may be swapped as needed in other configurations.

A fourth approach to enhance the SST protocol is to keep the TWT Channel field 494′ as a single octet (that is, same as in prior art), and define each bit as follows:

The first two bits B0 and B1 identify the 80 MHz sub-band, for example, as follows:
B0B1=00 indicating P80 of P160;
B0B1=10 indicating S80 of P160;
B0B1=01 indicating P80 of S160; and
B0B1=11 indicating S80 of S160.
B2 and B3 are reserved for potential future bandwidth expansion or other uses.

Bits B4 to B7 indicate the specific 20 MHz segment within the 80 MHz sub-band indicated by B0 and B1, for example:
B4 indicates that the DSO channel is the lowest 20 MHz segment of the 80 MHz sub-band,
B5 indicates that the DSO channel is the second lowest 20 MHz segment of the 80 MHz sub-band,
B6 indicates that the DSO channel is the third lowest 20 MHz segment of the 80 MHz sub-band, and
B7 indicates that the DSO channel is the highest 20 MHz segment of the 80 MHz sub-band.

In some embodiments, each outer STA 112B-2 switch to a different DSO channel, the DSO or Enhanced SST Information field 484 (see FIG. 10) comprises an outer STA information list having a plurality of outer STA Information fields 502 (such as n STA Information fields 502). As shown in FIG. 14A, each outer STA Information field 502 is formatted in three (3) bytes, including a STA Association ID (AID) field 504 of 12 bits, a TWT Channel Indication field 494A of eight (8) or nine (9) bits, and the rest four (4) or three (3) bits 508 are reserved.

In various embodiments, the TWT Channel Indication field 494A of the outer STA Information field 502 may be expressed in nine (9) bits and use the above-described first or second approach for indicating the DSO channel information, or expressed in one (1) octet (that is, eight (8) bits) and use the above-described third or fourth approach for indicating the DSO channel information.

FIG. 14B shows another arrangement of the DSO or Enhanced SST Information field 484 which comprises zero (0) or n four-byte outer STA Information field 502. Each outer STA Information field 502 comprises the 12-bit STA AID 504 followed by four reserved bits 508 forming the first two bytes, and the 16-bit TWT Channel 494′ which comprises a TWT Channel Indication field 494A (not shown) of eight (8) or nine (9) bits, and four (4) or three (3) reserved bits (not shown).

In some embodiments, all inner STAs 112B-1 are restricted to the same spatial reuse transmit power. In these embodiments, the CSR information field 482 may be formatted in one (1) octet using the eight (8) bits to indicate the transmit power value in decibel-milliwatts (dBm).

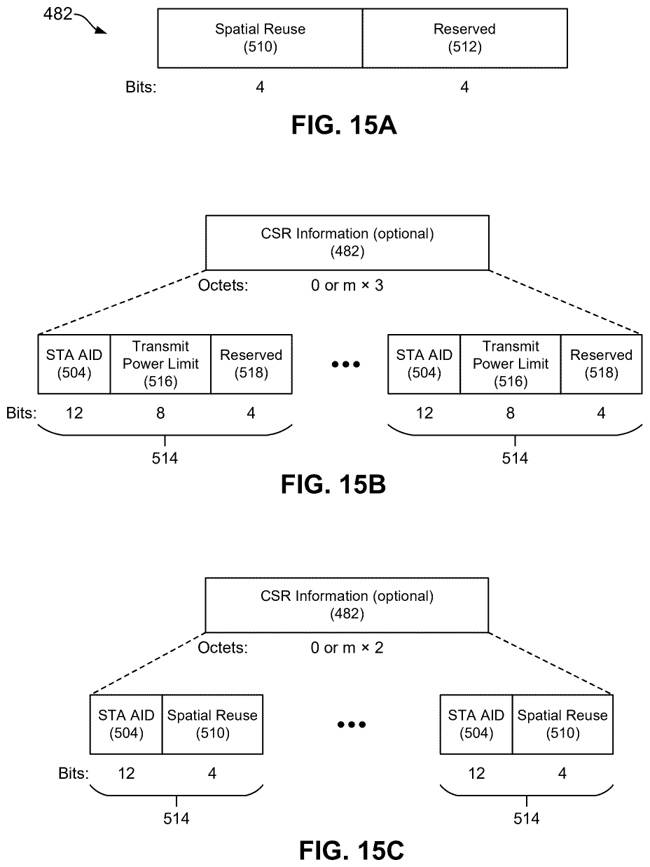

Alternatively, as shown in FIG. 15A, the CSR information field 482 may be formatted in one (1) octet and encodes the first four (4) bits as a Spatial Reuse field 510 whose values follow Table 27-24-Spatial Reuse field encoding for an HE TB PPDU (IEEE 802.11ax) [IEEE P802.11-REVme/D5.0] (reproduced below as Table 2) with the rest four (4) bits 512 reserved.

TABLE 2
Spatial Reuse field encoding for an HE TB PPDU (IEEE 802.11ax)

| Value | Meaning |
|---|---|
| 0 | PSR_DISALLOW |
| 1 | PSR = −80 (#3435) |
| 2 | PSR = −74 (#3435) |
| 3 | PSR = −68 (#3435) |
| 4 | PSR = −62 (#3435) |
| 5 | PSR = −56 (#3435) |
| 6 | PSR = −50 (#3435) |
| 7 | PSR = −47 (#3435) |
| 8 | PSR = −44 (#3435) |
| 9 | PSR = −41 (#3435) |
| 10 | PSR = −38 (#3435) |
| 11 | PSR = −35 (#3435) |
| 12 | PSR = −32 (#3435) |
| 13 | PSR = −29 (#3435) |
| 14 | PSR ≥ −26 (#3435) |
| 15 | PSR_AND_NON_SRG_OBSS_PD_PROHIBITED |

In some embodiments, each inner STA 112B-1 has its own spatial reuse transmit power value, as shown in FIG. 15B, the CSR information field 482 may comprise an inner STA Information list having a plurality of Inner STA Information fields 514 (such as m Inner STA Information fields 514). Each Inner STA Information field 514 is formatted in three (3) bytes and includes a STA AID field 504 of 12 bits, a Transmit Power Limit field 516 of eight (8) bits, and four (4) reserved bits 518.

Alternatively, as shown in FIG. 15C, the CSR information field 482 may comprise an inner STA Information list having a plurality of Inner STA Information fields 514 (such as m Inner STA Information fields 514). Each Inner STA Information field 514 is formatted in two bytes and includes a STA AID field 504 of 12 bits and a Spatial Reuse field 510 as described above.

As described above, the sharing AP 102A also broadcasts a TWT element via the beacon 322. If the sharing AP 102A and its associated STAs 112A will transmit at their maximum transmit power, the sharing AP 102A may utilize the conventional broadcast TWT element since it will broadcast only the SP's time parameters.

If the sharing AP 102A and its associated STAs 112A will follow the agreed CSR rules, the sharing AP 102A may use the CSR broadcast TWT element by setting the value of the modified Broadcast TWT Recommendation field 472′ in the modified Request Type field 442′ of the modified Broadcast TWT parameter Set field 410′ to five (5), and include the CSR parameters in the CSR information field 482 of the modified Broadcast TWT parameter Set field 410′.

In some embodiments, the sharing AP 102A may serve its inner STAs 112A-1 on its primary channel located within P160 and its outer STAs 112A-2 on a pre-defined DSO or enhanced SST channel located within S160.

In some embodiments, the sharing AP 102A and the shared AP 102B coordinate the maximum transmit powers for both the sharing AP 102A and its inner STAs 112A-1, and for the shared AP 102B and its inner STAs 112B-1. They also negotiate the DSO or enhanced SST channel location and bandwidth to be used by their respective outer STAs 112A-2 and 112B-2. This ensures a sufficient gap between the selected DSO or enhanced SST channels in each BSS to avoid OBSS interference between outer STAs 112A-2 and 112B-2 in overlapping BSSs. Additionally, they report the maximum DSO switching delay within each BSS and key SP parameters such as start times, durations, intervals, and/or the like.

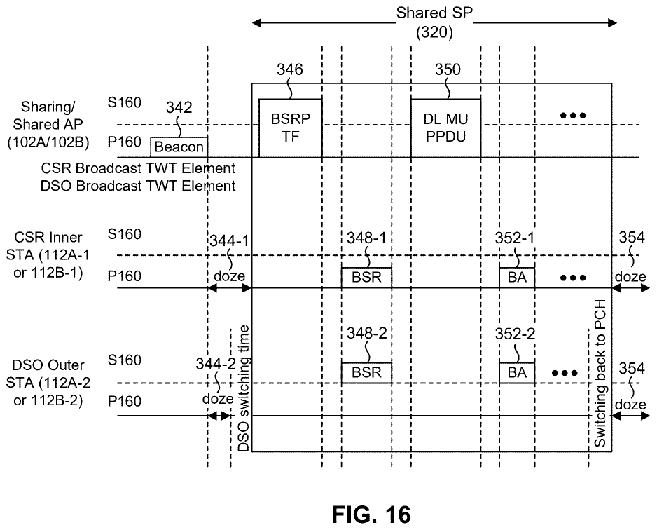

In this case, the communications between the sharing AP 102A and its STAs 112A follow the same process as the communications between the shared AP 102B and its STAs 112B as described above and shown in FIG. 8. FIG. 16 shows the communications of the sharing AP's BSS and the shared AP's BSS, which is substantially the same as the communications of the shared AP's BSS shown in the lower half of FIG. 8.

In some embodiments, the shared AP 102B may group its associated STAs 112B into one conventional trigger-based broadcast TWT agreement such that there is no need to define new types of Broadcast TWT Recommendation 472′ by utilizing the reserved values within the conventional Broadcast TWT Recommendation field 472. In other words, the shared AP 102B in these embodiments may simply use the conventional Broadcast TWT Recommendation field 472 with the Trigger field 466 set to one (1) to support trigger-enabled broadcast TWT.

At the start of each shared SP, the shared AP 102B determines its inner STAs 112B-1 and outer STAs 112B-2 based on the last STAs' reporting of beacon power received from the sharing AP 102A.

Then, the shared AP 102B sends an ICF (which is a trigger frame such as a MU-RTS trigger frame, a BSRP TF, a basic trigger frame, a MU-BAR trigger frame, a Multi-STA BA, or the like) to trigger one or more STAs 112B such as one or more outer STAs 112B-2 to switch to their designated DSO channels, and to trigger one or more STAs 112B such as one or more inner STAs 112B-1 to follow the CSR rules over the primary channel.

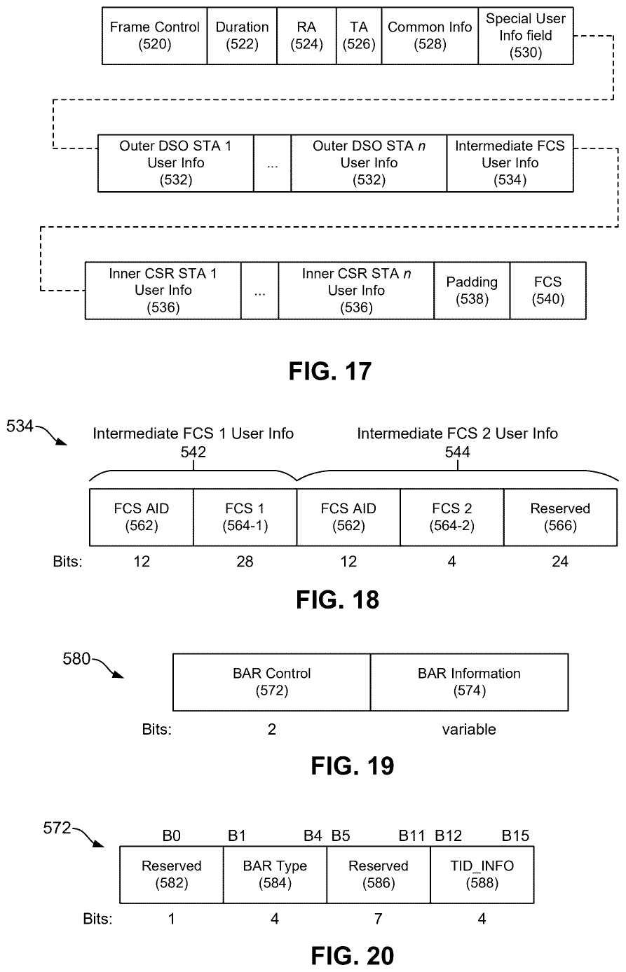

In these embodiments, the format of the ICF or trigger frame sent by the shared AP 102B is shown in FIG. 17, which comprises a Frame Control field 520, a Duration field 522, a Receiver Address (RA) field 524, a Transmitter Address (TA) field 526, a Common Information field 528, one or more Outer DSO STA User Info fields 532 (comprising the STA AID and DSO channel information) for triggering the outer STAs 112B-2 to switch to the DSO channel, an Intermediate Frame Check Sequence (FCS) User Info field 534, one or more Inner CSR STA User Info fields 536 (comprising the STA AID and spatial reuse value) for triggering the inner STAs 112B-1 to use CSR parameters, a Padding field 538 of a variable length, and a FCS field 540. In these embodiments, the Intermediate FCS User Information field 534 and the Padding field 538 are included for giving the DSO outer STAs 112B-2 sufficient time to decode the received ICF, transit to their DSO channel, and respond to the ICF after the Short Interframe Space (SIFS) time.

In these embodiments, the Intermediate FCS User Information field 534 may have a special, 12-bit FCS AID greater than 2007 (note that the conventional AID is between 0 and 2007), the Intermediate FCS User Information field 534 is shown in FIG. 18, wherein the intermediate FCS user information is split to a first intermediate FCS user information 542 comprising the 12-bit FCS AID 562 and a 28-bit first portion 564-1 of the FCS, and a second intermediate FCS user information 544 comprising the 12-bit FCS AID 562 and a second portion 564-2 of the FCS (such as a four-bit second portion 564-2 of the FCS with the rest of 24 bits reserved (566)).

One of the options is to include the CSR or/and DSO parameters within the Trigger Dependent User Info field of a MU-BAR trigger frame.

As shown in FIG. 19, the Trigger Dependent User Info field 580 comprises a BAR Control field 572 and a BAR Information field 574. As shown in FIG. 20, the BAR Control field 572 (for block acknowledgment request) comprises a first reserved field 582, a BAR Type field 584, a second reserved field 586, and a TID_INFO field 588.

In prior art, the values of the BAR Type field 584 are defined in Table 3.

TABLE 3
Values of the BAR Type field

| BAR Type field | BlockAckReq frame variant |
|---|---|
| 0 | Reserved |
| 1 | Extended Compressed |
| 2 | Compressed |
| 3 | Multi-TID |
| 4-5 | Reserved |
| 6 | GCR |
| 7-9 | Reserved |
| 10 | GLK-GCR |
| 11-15 | Reserved |

In these embodiments, the CSR or/and DSO parameters may be indicated by using two of the reserved values (bits 4-5, 7-9, or 11-15; highlighted in Table 3).

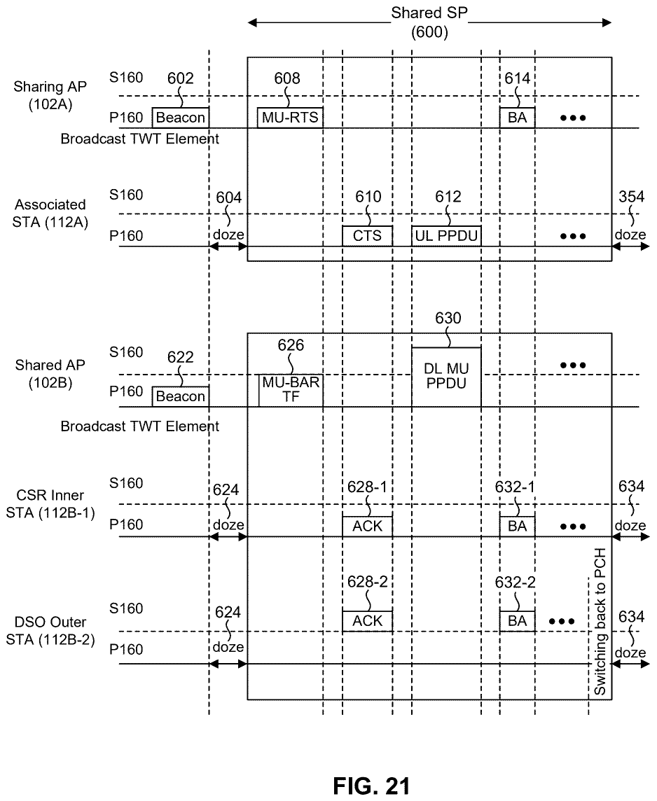

FIG. 21 is a timing diagram showing an example of the details of operations within the shared SP 600 between the sharing AP 102A and the shared AP 102B in these embodiments. In this example, the primary channel is located within the 160 MHz P160 and the secondary, DSO channel is located within the 160 MHz S160.

As shown, once the sharing AP 102A and shared AP 102B agree upon the CSR, DSO, and SP parameters, the sharing AP 102A broadcasts its SP parameters to its associated STAs 112A using a broadcast TWT element included in a beacon frame 602 through the primary channel located within P160.

Once the STAs 112A associated with the sharing AP 102A receive the beacon frame 322 and know their SP scheduling, they go in the doze state 604 and wake-up at the SP start time.

The communications between the sharing AP 102A and its associated STAs 112A may be conducted through the primary channel located within P160 in the conventional manner. For example, during the shared SP 600, the sharing AP 102A may send a trigger frame 608 (such as a MU-RTS trigger frame, a BSRP TF, a basic trigger frame, a MU-BAR trigger frame, a Multi-STA BA, or the like) to its associated STAs 112A, and then conduct communications therebetween using their maximum transmit power or by following the CSR transmit power control rules by limiting their transmit power or adjust their MCS. In the example shown in FIG. 21, after wakeup, the STA 112A sends a CTS frame 610 to the sharing AP 102A followed by a UL PPDU 612. After receiving the UL PPDU 612, the sharing AP 102A responds with a block ACK (BA) 614.

Meanwhile, the shared AP 102B broadcasts the shared SP parameters to its associated STAs 112B using a broadcast TWT element included in a beacon frame 622 through the primary channel located within P160.

Once the STAs 112B of the shared AP 102B receive the beacon frame 622 and know their SP scheduling, they go in the doze state 624. All STAs 112B of the shared AP 102B wake up at the start of the shared SP 600.

At the start of the shared SP 600, the shared AP 102B determines its inner STAs 112B-1 and outer STAs 112B-2 based on the last STAs' reporting of Beacon power received from the sharing AP 102A.

Then, the shared AP 102B sends an ICF 626 (which is a trigger frame such as a MU-RTS trigger frame, a BSRP TF, a basic trigger frame, a MU-BAR trigger frame, a Multi-STA BA, or the like) to its STAs 112B using both the primary channel located within P160 and the DSO channel located within S160 to trigger one or more STAs 112B such as one or more outer STAs 112B-2 to switch to their designated DSO channels, and to trigger one or more STAs 112B such as one or more inner STAs 112B-1 to follow the CSR rules over the primary channel. In these embodiments, the ICF 626 has to accommodate the maximum DSO switching delay among outer STAs 112B-2.

Based on the trigger and CSR parameters included in their User Info field within the ICF 626, each inner STA 112B-1 of the shared AP 102B follows the CSR transmission parameters and respond to the ICF 626 by sending an ACK 628-1 or Initial Control Response (ICR) frame over its primary channel located within P160.

Based on the trigger and DSO parameters included in their User Info field within the ICF 626, each outer STA 112B-2 of the shared AP 102B responds to the ICF 626 by sending an ACK 628-2 or Initial Control Response (ICR) frame over its DSO channel located within S160 with its maximum power.

In communications with its associated STAs 112B, the shared AP 102B follows the CSR rules in terms of the transmit power and MCS level as agreed with the sharing AP 102A during its downlink transmission.

For example, the shared AP 102B may send a DL MU PPDU 630 to its associated STAs 112B using both the primary channel located within P160 and the DSO channel located within S160. After receiving the DL MU PPDU 630, the inner STAs 112B-1 respond with a BA 632-1 via the primary channel located within P160, and the outer STAs 112B-2 respond with a BA 632-2 via the DSO channel located within S160.

The above-described communication may repeat until the shared SP 600 ends, at which time the outer STAs 112B-2 switch back to the PCH located within P160. Of course, after the shared SP 600 ends, the STAs 112 may go in the doze state 634.

In some embodiments, the sharing AP 102A may serve its inner STAs 112A-1 on its primary channel located within P160 and its outer STAs 112A-2 on a pre-defined DSO or enhanced SST channel located within S160.

In some embodiments, the sharing AP 102A and the shared AP 102B coordinate the maximum transmit powers for both the sharing AP 102A and its inner STAs 112A-1, and for the shared AP102B and its inner STAs 112B-1. They also negotiate the DSO or enhanced SST channel location and bandwidth to be used by their respective outer STAs 112A-2 and 112B-2. This ensures a sufficient gap between the selected DSO or enhanced SST channels in each BSS to avoid OBSS interference between outer STAs 112A-2 and 112B-2 in overlapping BSSs. Additionally, they report the maximum DSO switching delay within each BSS and key SP parameters, such as start times, durations, and intervals.

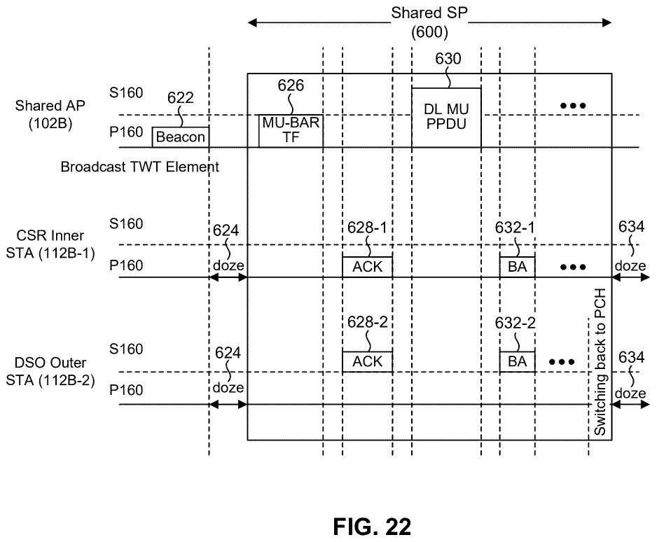

In this case, the communications between the sharing AP 102A and its STAs 112A follow the same process as the communications between the shared AP 102B and its STAs 112B as described above and shown in FIG. 21. FIG. 22 shows the communications of the sharing AP's BSS and the shared AP's BSS, which is substantially the same as the communications of the shared AP's BSS shown in the lower half of FIG. 21.

In some embodiments, an enhanced TXOP-CSR method employing DSO may be used. According to this method, APs 102 such as AP 102A and AP 102B within a CSR group pre-determine their inner STAs 112-1 and outer STAs 112-2 on a semi-static basis.

After agreeing on the CSR and DSO parameters, AP 102A and AP 102B broadcast these parameters in a beacon frame.

When one of AP 102A and AP 102B (for example, AP 102A) obtains the TXOP, it becomes the sharing AP, and the other one of AP 102A and AP 102B (for example, AP 102B) becomes the shared AP. The sharing AP 102A sends a specific ICF (such as a MU-RTS trigger frame, a BSRP TF, a basic trigger frame, a MU-BAR trigger frame, a Multi-STA BA, or the like) to trigger a CSR transmission with the shared AP 102B.

The shared AP 102B determines its inner STAs 112B-1 and outer STAs 112B-2 on a semi-static basis or based on the last STAs' reporting of Beacon power received from the sharing AP. After receiving the CSR trigger frame, the shared AP 102B sends a control response frame to its outer STAs 112B-2 to trigger these STAs to switch to their DSO channel, and trigger its inner STAs 112B-1 to follow the CSR guidelines. In these embodiments, this control response frame accommodates the maximum DSO switching delay among the outer non-AP STAs 112B-2 by using the Intermediate FCS User Information field 534 and the variable-length Padding field 538.

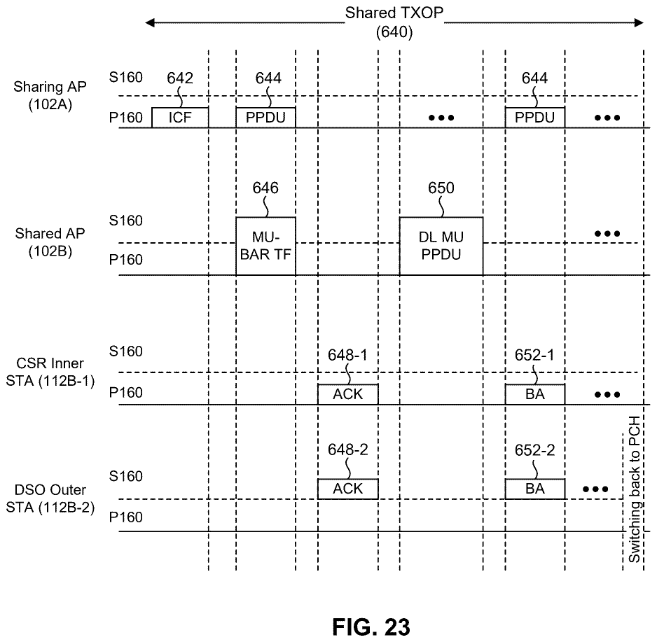

FIG. 23 is a timing diagram showing an example of the details of operations within the shared TXOP 640 between the sharing AP 102A and the shared AP 102B in these embodiments. In this example, the primary channel is located within the 160 MHz P160 and the secondary, DSO channel is located within the 160 MHz S160.

In this example, AP 102A obtains the TXOP and becomes the sharing AP. AP 102B then becomes the shared AP. The sharing AP 102A sends a specific ICF 642 (such as a MU-RTS trigger frame, a BSRP TF, a basic trigger frame, a MU-BAR trigger frame, a Multi-STA BA, or the like) to trigger a CSR transmission with the shared AP 102B.

After receiving the CSR trigger frame 642, the shared AP 102B responds with a control response frame 646 (which may be any suitable trigger frame such as a MU-RTS trigger frame, a BSRP TF, a basic trigger frame, a MU-BAR trigger frame, a Multi-STA BA, or the like) to its STAs 112B to trigger its outer STAs 112B-2 to switch to their DSO channel, and trigger its inner STAs 112B-1 to follow the CSR guidelines.

Based on the trigger and CSR parameters included in their User Info field within the ICF 642, each inner STA 112B-1 of the shared AP 102B follows the CSR transmission parameters and respond to the ICF, for example, by sending an ACK 648-1.

Based on the trigger and DSO parameters included in their User Info field within the ICF, each outer STA 112B-2 of the shared AP 102B responds to the ICF over its DSO channel with its maximum power.

Then, the shared AP 102B follows the CSR rules in terms of the transmit power and MCS level as agreed with the sharing AP 102A during its downlink transmission. For example, as shown in FIG. 23, the shared AP 102B may send a DL MU PPDU 650 using both the primary channel located within P160 and the DSO channel located within S160. The inner STAs 112B-1 of the shared AP 102B receive the DL MU PPDU 650 on the primary channel located within P160 and responds with a BA 652-1 over the primary channel located within P160. The outer STAs 112B-2 of the shared AP 102B receive the DL MU PPDU 650 on the DSO channel located within S160 and responds with a BA 652-1 over the DSO channel located within S160.

Meanwhile, the communications between the sharing AP 102A and its associated STAs 112A may be conducted through the primary channel located within P160 in the conventional manner (for example, sending one or more PPDUs 644 over the primary channel located within P160) by using their maximum transmit power or by following the CSR transmit power control rules by limiting their transmit power or adjust their MCS.

The above-described communication may repeat until the duration of the shared TXOP 640 ends, at which time the outer STAs 112B-2 switch back to the PCH located within P160.

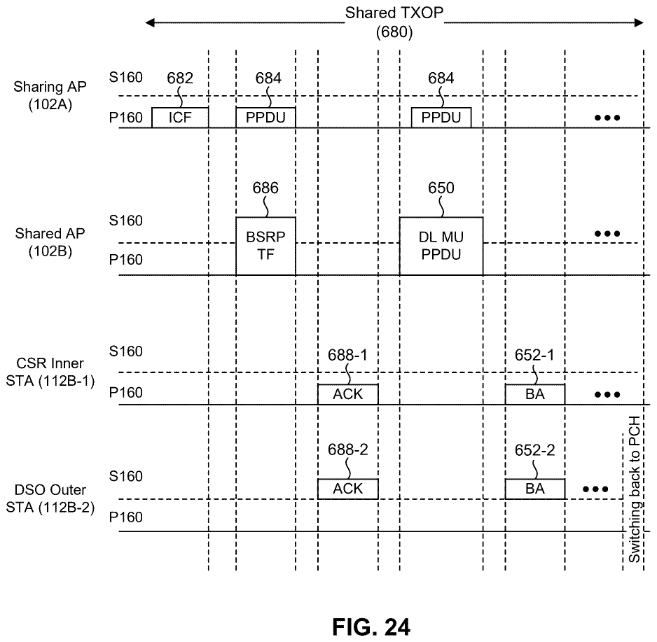

FIG. 24 is a timing diagram showing an example of the details of operations within the shared TXOP 680 between the sharing AP 102A and the shared AP 102B, according to some embodiments of this disclosure. In this example, the primary channel is located within the 160 MHz P160 and the secondary, DSO channel is located within the 160 MHz S160.

After agreeing on the CSR and DSO parameters, AP 102A and AP 102B broadcast these parameters in a beacon frame.

When one of AP 102A and AP 102B (for example, AP 102A) obtains the TXOP, it becomes the sharing AP, and the other one of AP 102A and AP 102B (for example, AP 102B) becomes the shared AP. The sharing AP 102A sends a specific ICF 682 (such as a MU-RTS trigger frame, a BSRP TF, a basic trigger frame, a MU-BAR trigger frame, a Multi-STA BA, or the like) to trigger a CSR transmission with the shared AP 102B. This ICF 682 has to accommodate the maximum DSO switching delay at the shared AP's BSS.

The shared AP 102B determines its inner STAs 112B-1 and outer STAs 112B-2 on a semi-static basis or based on the last STAs' reporting of Beacon power received from the sharing AP.

After detecting the OBSS ICF trigger frame 682, each STA 112B associated with the shared AP 102B has to determine either to support CSR (that is, acting as an inner STA 112B-1) or DSO (that is, acting as an outer STA 112B-2).

In some embodiments, the CSR/DSO selection may be performed based on the received signal strength such as the received signal strength indication (RSSI) of the OBSS TF 682. For example, when the received signal strength such as the RSSI of the sharing AP's ICF 682 is smaller than a predefined or predetermined OBSS packet detection (OBSS PD) threshold, the STA 112B may select to support CSR. The STA 112B then acts as an inner STA 112B-1 and follows the CSR rules announced in the beacon frame. On the other hand, when the received signal strength such as the RSSI of the sharing AP's ICF 682 is greater than or equal to the predefined or predetermined OBSS PD threshold, the STA 112B may select to support DSO. The STA 112B then acts as an outer STA 112B-2 and starts to switch to its DSO channel announced in the beacon frame.

After receiving the OBSS ICF trigger frame 682, the shared AP 102B sends a trigger frame 686 (such as a MU-RTS trigger frame, a BSRP TF, a basic trigger frame, a MU-BAR trigger frame, a Multi-STA BA, or the like) to its STAs 112B to confirm the subchannel on which each associated STA 112B stays.

After classifying itself as an inner STA 112B-1, each inner STA 112B-1 of the shared AP 102B follows the CSR transmission parameters and responds to the shared AP's trigger frame 686 by sending an ACK 688-1, BSR or any other ICR (depending on the type of the trigger frame sent by the shared AP) over its primary channel located within P160.

After classifying itself as an outer STA 112B-2, each outer STA 112B-2 of the shared AP 102B responds to the shared AP's trigger frame 686 by sending an ACK 688-2, BSR or any other ICR (depending on the type of the trigger frame sent by the shared AP) over its DSO channel located within S160 with its maximum power.

The shared AP 102B follows the CSR rules in terms of the transmit power and MCS level as agreed with the sharing AP 102A during its downlink transmission.

Meanwhile, the communications between the sharing AP 102A and its associated STAs 112A may be conducted through the primary channel located within P160 in the conventional manner (for example, sending one or more PPDUs 684 over the primary channel located within P160) by using their maximum transmit power or by following the CSR transmit power control rules by limiting their transmit power or adjust their MCS.

The above-described communication may repeat until the duration of the shared TXOP 680 ends, at which time the outer STAs 112B-2 switch back to the PCH located within P160.

In above embodiments, a semi-static classification approach is used, where all users are classified once and this classification remains unchanged over time. In some other embodiments, at the beginning of each shared TXOP or SP, the AP 102 may dynamically classify its associated STAs 112 based on the most recent beacon power report of the interfering AP from its associated STAs. This means the classification can change with each SP or TXOP. In yet some other embodiments, STAs 112 independently classify themselves based on the RSSI value of the ICF sent by the sharing AP 102A and the OBSS PD threshold, offering a dynamic, self-regulated classification method.

Herein, various embodiments of enhanced CSR methods are disclosed. The enhanced CSR methods disclosed herein may be used by WI-FI® APs and STAs with MAP, CSR, enhanced SST and DSO capabilities, such as WI-FI® 8 AP or device. The enhanced CSR methods disclosed herein is also related to the standardization of next generation of IEEE 802.11 technologies for MAP.

The enhanced CSR methods disclosed herein address several critical issues inherent in the conventional methods of CSR scheduling, particularly in, for example, handling outer STAs 112B at the cell edge in OBSSs. More specifically, the enhanced CSR methods disclosed herein solve at least some of the following technical problems:
1. High Latency for Outer STAs: In prior art, outer STAs are scheduled on separate orthogonal SPs or TXOPs to avoid OBSS interference, resulting in significant delays. Outer STAs must wait for the shared CSR periods allocated to inner STAs to complete before their own communication begins, causing high latency that degrades the performance of latency-sensitive applications. Thus, there is a need to reduce the waiting time for outer STAs and mitigate the delay, especially for real-time applications such as video conferencing and VoIP.
2. Inefficient Use of Bandwidth: In prior art, outer STAs are scheduled on isolated SPs or TXOPs. Consequently, the available spectrum is underutilized, as the simultaneous transmission potential is not fully leveraged. This reduces the overall network efficiency, particularly in, for example, dense environments. Thus, there is a need to enable more efficient spectrum utilization by allowing simultaneous transmissions from both inner and outer STAs without causing OBSS interference.
3. Static STA Classification: Conventional methods rely on semi-static classification of inner and outer STAs, which do not adapt to the changing interference conditions or STA mobility. This leads to suboptimal performance, particularly for, for example, outer STAs in dynamic environments. Thus, there is a need to implement adaptive classification mechanisms that adjust to fluctuating interference and mobility, ensuring efficient communication for both inner and outer STAs.
4. Inconsistent Performance for Outer STAs: In prior art, outer STAs suffer from reduced performance due to being disproportionately affected by interference and the rigid scheduling mechanisms in place. Thus, there is a need to provide more consistent and reliable service for outer STAs by addressing interference and optimizing scheduling strategies.

The enhanced CSR methods disclosed herein use a novel approach for CSR scheduling, which aims to solve at least some of the above-described technical problems and enhance network performance, such as for outer STAs. More specifically, the enhanced CSR methods disclosed herein provide the following technical features for solving at least some of the above-described technical problems:
1. Simultaneous Communication for Inner and Outer STAs: Instead of isolating outer STAs on separate orthogonal SPs/TXOPs, the enhanced CSR methods disclosed herein allow both inner and outer STAs to transmit simultaneously during shared CSR SPs/TXOPs. The inner STAs associated with the shared AP follow the CSR rules, and the outer STAs associated with shared AP switch to predefined or predetermined DSO channels within the shared AP's operating bandwidth. Thus, the methods disclosed herein reduces the need for orthogonal SPs/TXOPs scheduling and improves overall network throughput.
2. Optimized Spectrum Utilization: By enabling simultaneous communication for inner and outer STAs, the enhanced CSR methods disclosed herein ensure more efficient utilization or even full utilization of the available bandwidth, particularly in, for example, high-demand and congested environments. Both inner and outer STAs may take advantage of the spectrum at the same time, thereby increasing overall throughput and network efficiency, particularly in, for example, high-demand environments and scenarios involving OBSSs.
3. Reduced Latency for Outer STAs: The enhanced CSR methods disclosed herein address high-latency issues by enabling outer STAs to transmit without having to wait for inner STAs to complete their scheduled SP or TXOP transmissions. By drastically reducing the waiting time for outer STAs, the enhanced CSR methods disclosed herein ensure that latency-sensitive applications, such as real-time communication, online gaming, video conferencing, VoIP, and the like, can perform better even at the cell edge, thereby providing a smoother user experience.
4. Adaptive STA Classification: The enhanced CSR methods disclosed herein introduce dynamic classification criteria for inner and outer STAs, wherein the classification of inner and outer STAs is dynamically adjusted based on real-time interference levels and STA mobility at the start of each SP or TXOP. This adaptability ensures that the system can adapt to changing interference levels and STA mobility, and effectively respond to fluctuating network conditions, leading to flexible and efficient scheduling and optimized resource allocation for high-quality communication, even in rapidly changing environments.
5. Improved Service Quality for Outer STAs: The enhanced CSR methods disclosed herein allow outer STAs to transmit during shared CSR SPs/TXOPs using their maximum transmit power without causing OBSS interference, resulting in more stable and reliable communications. By mitigating interference and providing flexible scheduling, the service quality for outer STAs, especially those located at the cell edge, is significantly improved with enhanced consistency and reliability, thereby enhancing the overall user experience, especially for users at the edge of the network.

### C. Acronyms, Abbreviations, and Definition of Some Terms

| | Acronym/ |
|---|---|
| Full | Abbreviation/ |
| Name | Initialism |
| Access Category | AC |
| Access Point | AP |
| AID | Associated |
| | Identifier |
| Basic Service Set | BSS |
| Block Acknowledgement | BA |
| Block Acknowledgement Request | BAR |
| Buffer Status Report Poll | BSRP |
| Buffer Status Report | BSR |
| Clear-to-Send | CTS |
| Coordinated Non- | Co-NPCA |
| Primary Channel | |
| Access | |
| Coordinated Spatial Reuse | CSR |
| Distributed | DCF |
| Coordination Function | |
| Downlink | DL |
| Dynamic Sub-band Operation | DSO |
| Dynamic Sub-channel Operation | DSO |
| Enhanced Distributed | EDCA |
| Channel Access | |
| Enhanced Distributed | EDCAF |
| Channel Access | |
| Hybrid Coordination | HCF |
| Function | |
| Initial Control Frame | ICF |
| Least Significant Bit | LSB |
| Multi-AP | MAP |
| Multi-Stations | Multi-STA BA |
| Block Acknowledgement | |
| Multi-User | MU-BAR |
| Block Acknowledgement | |
| Request | |
| Multi-User | MU-RTS |
| Request-to-Send | |
| Non-Primary | NPCA |
| Channel Access | |
| Overlapping Basic | OBSS |
| Service Set | |
| Physical | PHY |
| Reception | RX |
| Signal-to-Interference- | SINR |
| plus-Noise-Ratio | |
| Service Period | SP |
| Station | STA |
| Target Beacon | TBTT |
| Transmission Time | |
| Transmission | TX |
| Transmission | TXOP |
| Opportunity | |
| To Be Defined | TBD |
| Ultra-High | UHR |
| Reliability | |
| Uplink | UL |
| Wireless LAN | WLAN |

Herein, the term “predefined” (for example, a “predefined” item such as a “predefined” parameter) refers to an item defined before the method disclosed herein is performed (for example, defined as a system design parameter such as defined by relevant standards).

Herein, the term “preconfigured” (for example, a “preconfigured” item such as a “preconfigured” parameter) refers to an item configured by a suitable apparatus before a certain even occurs.

Herein, use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

Herein, various embodiments are described. In various embodiments, the methods disclosed herein may be implemented as hardware, software, firmware, or a combination thereof, and may be implemented in any suitable form. Depending on the functionalities of various features of the methods disclosed herein, some features may be implemented on the network side (such as in one or more APs), some other features may be implemented on the STA side, and/or yet some other features may be implemented on both the AP and the STA sides. Depending on the functionalities of various features of the methods disclosed herein, some features may be implemented on the transmitting side (such as in one or more APs and/or one or more STAs for transmission), some other features may be implemented on the receiving side (such as in one or more APs and/or one or more STAs for receiving), and/or yet some other features may be implemented on both the transmitting and the receiving sides.

For example, in some embodiments, the methods disclosed herein may be implemented as computer-executable instructions stored in one or more non-transitory computer-readable storage devices (in the form of software, firmware, or a combination thereof) such that, the instructions, when executed, may cause one or more physical components such as one or more circuits to perform the methods disclosed herein.

For example, in some embodiments, an apparatus comprising one or more processors functionally connected to one or more non-transitory computer-readable storage devices or media may be used to perform the methods disclosed herein, wherein the one or more non-transitory computer-readable storage devices or media store the computer-executable instructions of the methods disclosed herein, and the one or more processors may read the computer-executable instructions from the one or more non-transitory computer-readable storage devices or media, and executes the instructions to perform the methods disclosed herein.

In some embodiments, an apparatus may not have any processors or computer-readable storage devices or media. Rather, the apparatus may comprise any other suitable physical or virtual (explained below) components for implementing the methods disclosed herein.

In some embodiments, the computer-executable instructions that implement the methods disclosed herein may be one or more computer programs, one or more program products, or a combination thereof.

In some embodiments, the methods disclosed herein may be implemented as one or more circuits, one or more components, one or more units, one or more modules, one or more integrated-circuit (IC) chips, one or more chipsets, one or more devices, one or more apparatuses, one or more systems, and/or the like.

The one or more circuits, one or more components, one or more units, one or more modules, one or more IC chips, one or more chipsets, one or more devices, one or more apparatuses, or one or more systems may be physical, virtual, or a combination thereof. Herein, the term “virtual” (such as a “virtual apparatus”) refers to a circuit, component, unit, module, chipset, device, apparatus, system, or the like that is simulated or emulated or otherwise formed using suitable software or firmware such that it appears as if it is “real” or physical).

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

Although this disclosure refers to illustrative embodiments, this is not intended to be construed in a limiting sense. Various modifications and combinations of the illustrative embodiments, as well as other embodiments of the disclosure, will be apparent to persons skilled in the art upon reference to the description.

Features disclosed herein in the context of any particular embodiments may also or instead be implemented in other embodiments. Method embodiments, for example, may also or instead be implemented in apparatus, system, and/or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

Those skilled in the art will appreciate that the various embodiments and/or features disclosed herein may be customized and/or combined as needed or desired. Moreover, although embodiments have been described above with reference to the accompanying drawings, those of skill in the art will appreciate that variations and modifications may be made without departing from the scope thereof as defined by the appended claims.

What is claimed is:

1. A communication method comprising:
communicating with an access point (AP) to determine a coordinated spatial reuse (CSR) arrangement therewith, the CSR arrangement comprising information of a first channel, a second channel, a service period (SP) or transmission opportunity (TXOP), and one or more CSR-related parameters;
broadcasting to a plurality of stations (STAs) a first frame comprising the CSR arrangement;
during the SP or TXOP, communicating with a first subset of the plurality of STAs over the first channel using the one or more CSR-related parameters; and
during the SP or TXOP, communicating with a second subset of the plurality of STAs over the second channel.

2. The communication method of claim 1, wherein the first channel is in a primary band and the second channel is a dynamic sub-band operation (DSO) channel in a secondary band.

3. The communication method of claim 1, wherein the first frame comprises a single target wake time (TWT) element or two aligned broadcast TWT elements.

4. The communication method of claim 3, wherein the first frame comprises two aligned trigger-based broadcast TWT elements; and
wherein each of the two aligned trigger-based broadcast TWT elements comprises a Broadcast TWT Parameter Set field;
wherein the Broadcast TWT Parameter Set field comprises a Request Type field;
wherein the Request Type field comprises a Trigger field having a value of one; and
wherein the Request Type field further comprises a Broadcast TWT Recommendation field having a value of five for indicating using the first channel or a value of six for indicating using the second channel.

5. The communication method of claim 1, wherein the first frame comprises a single TWT element;
wherein the communication method further comprises:
sending to the plurality of STAs a second frame; and
wherein the second frame comprises information of the first subset of the plurality of STAs, and information of the second subset of the plurality of STAs.

6. The communication method of claim 1 further comprising:
receiving a third frame;
wherein the third frame is configured for triggering said broadcasting to the plurality of STAs the first frame comprising the CSR arrangement;
wherein the CSR arrangement comprises the information of the TXOP; and
wherein the first frame is configured to trigger the first subset of the plurality of STAs to communicate over the first channel using the one or more CSR-related parameters, and to trigger the second subset of the plurality of STAs to communicate over the second channel.

7. One or more processors functionally coupled to one or more non-transitory computer-readable storage media, wherein the one or more non-transitory computer-readable storage media comprise computer-executable instructions; and wherein the instructions, when executed, cause the one or more processors to perform the method of claim 1.

8. The one or more processors of claim 7, wherein the first frame comprises two aligned trigger-based broadcast TWT elements; and
wherein each of the two aligned trigger-based broadcast TWT elements comprises a Broadcast TWT Parameter Set field;
wherein the Broadcast TWT Parameter Set field comprises a Request Type field;
wherein the Request Type field comprises a Trigger field having a value of one; and
wherein the Request Type field further comprises a Broadcast TWT Recommendation field having a value of five for indicating using the first channel or a value of six for indicating using the second channel.

9. The one or more processors of claim 7, wherein the first frame comprises a single TWT element;
wherein the instructions, when executed, cause the one or more processors to perform further actions comprising:
sending to the plurality of STAs a second frame; and
wherein the second frame comprises information of the first subset of the plurality of STAs, and information of the second subset of the plurality of STAs.

10. The one or more processors of claim 7, wherein the instructions, when executed, cause the one or more processors to perform further actions comprising:
receiving a third frame;
wherein the third frame is configured for triggering said broadcasting to the plurality of STAs the first frame comprising the CSR arrangement;
wherein the CSR arrangement comprises the information of the TXOP; and
wherein the first frame is configured to trigger the first subset of the plurality of STAs to communicate over the first channel using the one or more CSR-related parameters, and to trigger the second subset of the plurality of STAs to communicate over the second channel.

11. One or more non-transitory computer-readable storage media comprising computer-executable instructions, wherein the instructions, when executed, cause one or more processors to perform the method of claim 1.

12. The one or more non-transitory computer-readable storage media of claim 11, wherein the first channel is in a primary band and the second channel is a dynamic sub-band operation (DSO) channel in a secondary band.

13. The one or more non-transitory computer-readable storage media of claim 11, wherein the first frame comprises a single target wake time (TWT) element or two aligned trigger-based broadcast TWT elements.

14. The one or more non-transitory computer-readable storage media of claim 13, wherein the first frame comprises two aligned trigger-based broadcast TWT elements; and
wherein each of the two aligned trigger-based broadcast TWT elements comprises a Broadcast TWT Parameter Set field;
wherein the Broadcast TWT Parameter Set field comprises a Request Type field;
wherein the Request Type field comprises a Trigger field having a value of one; and
wherein the Request Type field further comprises a Broadcast TWT Recommendation field having a value of five for indicating using the first channel or a value of six for indicating using the second channel.

15. The one or more non-transitory computer-readable storage media of claim 14, wherein the first frame further comprises an CSR information field for indicating information related to the first channel, a DSO or Enhanced SST Information field, or a combination thereof for indicating information related to the second channel.

16. The one or more non-transitory computer-readable storage media of claim 13, wherein each TWT element comprises a TWT Channel field for indicating a location of the second channel.

17. The one or more non-transitory computer-readable storage media of claim 11, wherein the first frame comprises a single TWT element;
wherein the instructions, when executed, cause the one or more processors to perform further actions comprising:
sending to the plurality of STAs a second frame; and
wherein the second frame comprises information of the first subset of the plurality of STAs, and information of the second subset of the plurality of STAs.

18. The one or more non-transitory computer-readable storage media of claim 11, wherein the instructions, when executed, cause the one or more processors to perform further actions comprising:
receiving a third frame;
wherein the third frame is configured for triggering said broadcasting to the plurality of STAs the first frame comprising the CSR arrangement;
wherein the CSR arrangement comprises the information of the TXOP; and
wherein the first frame is configured to trigger the first subset of the plurality of STAs to communicate over the first channel using the one or more CSR-related parameters, and to trigger the second subset of the plurality of STAs to communicate over the second channel.

19. The one or more non-transitory computer-readable storage media of claim 11, wherein the first frame is configured for triggering each of the plurality of STAs to determine whether to use the first channel or to use the second channel for communication.

20. The one or more non-transitory computer-readable storage media of claim 11, wherein the first frame is configured for triggering each of the plurality of STAs to determine whether to use the first channel or to use the second channel for communication based on a comparison of a received signal strength (RSSI) of the first frame and an Overlapping Basic Service Set (OBSS) packet detection (OBSS PD) threshold.
